(19) United States
(12) Patent Application Publication
(10) Pub. No.: US 2026/0236962 A1
(43) Pub. Date: Aug. 13, 2026

(54) SERVICE PROCESSING METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Jin YOU, Shenzhen (CN); Jinkun HOU, Shenzhen (CN); Runzeng GUO, Shenzhen (CN); Shaoming WANG, Shenzhen (CN); Yongfeng LIU, Shenzhen (CN)

(73) Assignee: Tencent Technology (Shenzhen) Company Limited, Shenzhen, GD (CN)

(21) Appl. No.: 19/645,843

(22) Filed: Apr. 13, 2026

Related U.S. Application Data
(63) Continuation of application No. PCT/CN2025/100083, filed on Jun. 10, 2025.

(30) Foreign Application Priority Data
Jul. 26, 2024 (CN) 202411017424.9

(51) Int. Cl. G06Q 30/0251; G06Q 20/40; G06Q 30/0601

(52) U.S. Cl. CPC G06Q 30/0255; G06Q 20/40145; G06Q 30/06311

(57) ABSTRACT

This application provides a service processing method, a related apparatus, a device, and a storage medium. The method of this application includes: acquiring first biometric data in a case of displaying a first advertisement content, the first advertisement content being an advertisement content corresponding to a first item, and the first biometric data including a to-be-recognized biometric feature; obtaining, if the first biometric data is successfully matched with prestored biometric data, payment information corresponding to a target object, the prestored biometric data being biometric data acquired in advance for the target object; and executing, in response to a confirmation operation on order information for the first item, a payment operation according to the payment information. This application not only saves operation time and energy and improves order placement efficiency, but also helps to promote item sales, thereby improving an advertising value.

### RELATED APPLICATION

This application is a continuation application of PCT Patent Application No. PCT/CN2025/100083, filed on Jun. 10, 2025, which claims priority to Chinese Patent Application No. 2024110174249, filed with the China National Intellectual Property Administration on Jul. 26, 2024, each of which is incorporated herein by reference in its entirety.

### FIELD OF THE TECHNOLOGY

This application relates to the field of Internet technologies, and in particular, to service processing.

### BACKGROUND OF THE DISCLOSURE

A digital signage is a new-generation intelligent device, which forms a complete advertisement playback and control system by way of terminal software control, network transmission, and multimedia terminal display and delivers advertisement contents by using multimedia materials such as pictures, text, videos, and plug-ins. Interactivity of the digital signage enables the digital signage to have many public service functions, thereby attracting customers to actively browse advertisements.

Currently, in the related art, if a user is interested in item information displayed on the digital signage, the user may search for the item information on e-commerce platforms, web pages, or mini program pages by using a terminal (such as a mobile phone or a tablet computer). Further, if the user intends to purchase this item, the user may place an order and make payment through a designated page.

However, inventors find that current solutions have at least the following problem: The user needs to make payment by using the terminal after viewing advertisements displayed on an advertisement display module. An entire process is relatively cumbersome, which not only wastes operation time of the user, but also disfavors an advertisement delivery effect. For the problem, no effective solution has been provided yet.

### SUMMARY

Embodiments of this disclosure provide a service processing method, a related apparatus, a device, and a storage medium. This application not only saves operation time and energy and improves order placement efficiency, but also helps to promote item sales, thereby improving an advertising value.

In view of this, an aspect of this application provides a service processing method, including:
acquiring first biometric data in a case of displaying a first advertisement content, the first advertisement content being an advertisement content corresponding to a first item, and the first biometric data including a to-be-recognized biometric feature;
obtaining, if the first biometric data is successfully matched with prestored biometric data of a target object, payment information corresponding to the target object, the prestored biometric data being biometric data acquired in advance for the target object; and
executing, in response to a confirmation operation on order information for the first item, a payment operation according to the payment information.

Another aspect of this application provides a service processing apparatus, including:
an obtaining module, configured to acquire first biometric data in a case of displaying a first advertisement content, the first advertisement content being an advertisement content corresponding to a first item, and the first biometric data including a to-be-recognized biometric feature, and
the obtaining module being further configured to obtain, if the first biometric data is successfully matched with prestored biometric data of a target object, payment information corresponding to the target object, and the prestored biometric data being biometric data acquired in advance for the target object; and
a processing module, configured to execute, in response to a confirmation operation on order information for the first item, a payment operation according to the payment information.

Another aspect of this application provides a computer device, including a memory and a processor, the memory having a computer program stored therein, and the processor, when executing the computer program, implementing the method in the above aspects.

Another aspect of this application provides a computer-readable storage medium, having a computer program stored therein, the computer program, when executed by a processor, implementing the method in the above aspects.

Another aspect of this application provides a computer program product, including a computer program, the computer program, when executed by a processor, implementing the method in the above aspects.

It can be seen from the foregoing technical solutions that the embodiments of this application have the following advantages:

In the embodiment of this disclosure, the service processing method is provided. In a case of displaying the first advertisement content, the first biometric data may be acquired firstly. If the first biometric data is successfully matched with the prestored biometric data, the payment information corresponding to the target object is obtained. Based on this, in response to the confirmation operation on the order information, the payment operation may be executed according to the payment information. In the foregoing mode, when viewing the advertisement content, a user may directly place an order to purchase the item by way of biometric payments. This application not only saves operation time and energy and improves order placement efficiency, but also helps to promote item sales, thereby improving an advertising value.

### BRIEF DESCRIPTION OF THE DRAWINGS

FIG. 1 is a schematic diagram of an implementation environment of a service processing method according to an embodiment of this disclosure.

FIG. 2 is a schematic diagram of another implementation environment of a service processing method according to an embodiment of this disclosure.

FIG. 3 is a schematic diagram of another implementation environment of a service processing method according to an embodiment of this disclosure.

FIG. 4 is a schematic flowchart of a service processing method according to an embodiment of this disclosure.

FIG. 5 is a schematic diagram of confirming order information according to an embodiment of this disclosure.

FIG. 6 is a schematic diagram of queuing up to place an order according to an embodiment of this disclosure.

FIG. 7 is a schematic diagram of recommending an item information set according to an embodiment of this disclosure.

FIG. 8 is a schematic diagram of determining a purchase quantity according to an embodiment of this disclosure.

FIG. 9 is a schematic diagram of implementing order placement at a terminal based on a failed payment message according to an embodiment of this disclosure.

FIG. 10 is a schematic diagram of implementing delivery of different types of items according to an embodiment of this disclosure.

FIG. 11 is a schematic flowchart of an application of a service processing method according to an embodiment of this disclosure.

FIG. 12 is another schematic flowchart of a service processing method according to an embodiment of this disclosure.

FIG. 13 is a schematic diagram of uploading order review information according to an embodiment of this disclosure.

FIG. 14 is a schematic diagram of displaying a notification message indicating comment failed according to an embodiment of this disclosure.

FIG. 15 is a schematic diagram of highlighting violation words according to an embodiment of this disclosure.

FIG. 16 is a schematic diagram of displaying rating options according to an embodiment of this disclosure.

FIG. 17 is a schematic diagram of uploading object review information according to an embodiment of this disclosure.

FIG. 18 is a schematic diagram of uploading item review information according to an embodiment of this disclosure.

FIG. 19 is a schematic flowchart of another application of a service processing method according to an embodiment of this disclosure.

FIG. 20 is a schematic diagram of a service processing apparatus according to an embodiment of this disclosure.

FIG. 21 is a schematic structural diagram of a terminal according to an embodiment of this disclosure.

### DESCRIPTION OF EMBODIMENTS

Embodiments of this disclosure provide a service processing method, a related apparatus, a device, and a storage medium. This application not only saves operation time and energy and improves order placement efficiency, but also helps to promote item sales, thereby improving an advertising value.

In the specification, claims, and accompanying drawings of this application, the terms “first”, “second”, “third”, “fourth”, and the like (if any) are intended to distinguish between similar objects, but do not necessarily indicate a specific order or sequence. Data used in such a way is interchangeable in a proper case, so that the embodiments of this application described herein can be implemented, for example, in a sequence other than the sequence illustrated or described herein. Moreover, the terms “include”, “correspond to”, and any other variants are intended to cover the non-exclusive inclusion. For example, a process, method, system, product, or device that includes a series of operations or units is not necessarily limited to those expressly listed operations or units, but may include other operations or units not expressly listed or inherent to the process, method, product, or device.

With the rapid development of science and technologies, people's life styles are changing unprecedentedly. Especially, in the field of payment, the evolution has progressed from cash transactions to bank card payments, and then to code scanning payments. Nowadays, a new payment mode is rising, that is, biometric payments. Biometric payments are a payment mode based on biometric feature recognition. Biometric payments performs identity authentication and payment authorization based on biometric feature information such as fingerprints, faces, veins, irises, and voiceprints. This payment mode not only greatly improves payment security, but also makes a payment process more convenient and faster.

Biometric payments usually need to be supported by a payment interaction device (for example, a palm scanning device, a face scanning device, or a fingerprint scanning device). However, currently used payment interaction devices have monotonous functions and are applied in relatively fixed scenarios.

Based on this, in an embodiment of this disclosure, a service processing method is provided, which can implement more complex functions by using a terminal, to meet more scenario requirements, thereby helping to improve user experience. The service processing method provided in this application includes at least one of the following scenarios when being applied.

### Scenario 1: Place an Order to Purchase an Item.

A digital signage is placed in a place such as a shopping mall, a hotel, or a cinema, and bidirectional communication is available between the digital signage and a payment interaction device. While the digital signage displays advertisement contents (including item information, item prices, and the like), a user may perform identity authentication and payment authorization by using the payment interaction device. Moreover, after completing the identity authentication and the payment authorization, the user confirms to place an order for the item involved in the current advertisement content. After the payment is completed, a merchant may receive a related order and mails the item to a default mailing address preset by the user. Alternatively, the item may be directly provided by the digital signage, to implement offline direct item transactions.

### Scenario 2: Review Transaction Experience.

A user may make transactions in a place such as a restaurant or a coffee shop, and use a payment interaction device to perform identity authentication and payment authorization. After payment is successful, the payment interaction device prompts the user to review this transaction. Thereby, the user uploads speech data by using the payment interaction device and generates a corresponding review content according to the speech data. Further, a server updates the review content to a review page of a corresponding place, to facilitate viewing by another user.

### Scenario 3: Review an Item.

Self-checkout can bring intelligent and convenient payment experience to the user. In a place such as a shopping mall or a restaurant, a user selects items by using a payment interaction device and makes payment by way of self-ordering. After completing the payment, the user may further review one or more items purchased, for example, by inputting text contents, inputting speech contents, or selecting a rating option.

The foregoing application scenarios are merely examples, and the service processing method provided in this embodiment may also be applied to other scenarios. This is not limited herein.

In a specific implementation of this application, related data, such as user information, biometric data, and speech information is involved. When the embodiments of this application are applied to a specific product or technology, a license or consent of a user is required to be obtained, and collection, use, and processing of the related data are required to comply with related laws and regulations and standards of related countries and regions.

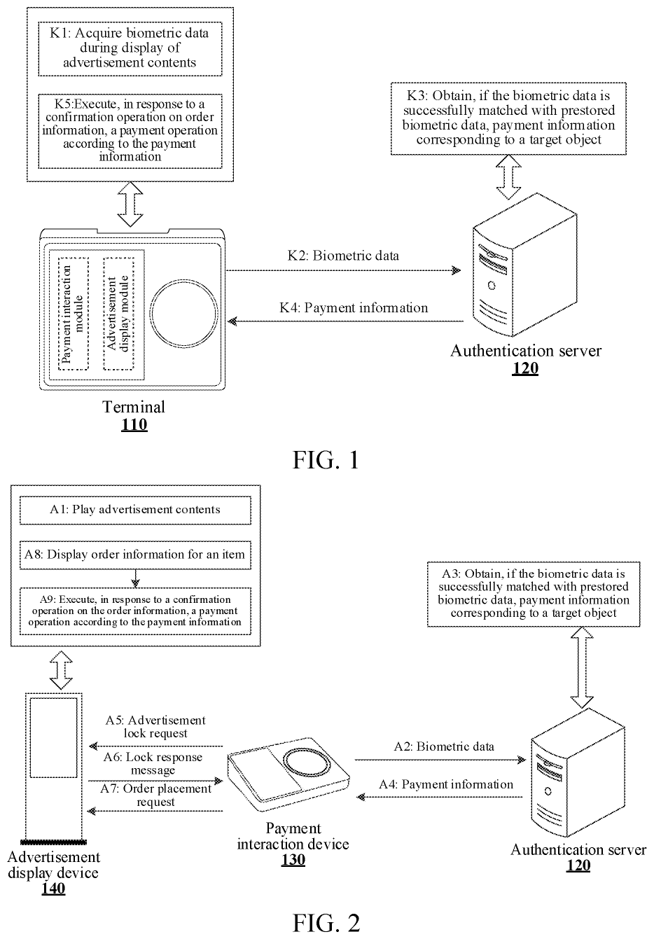

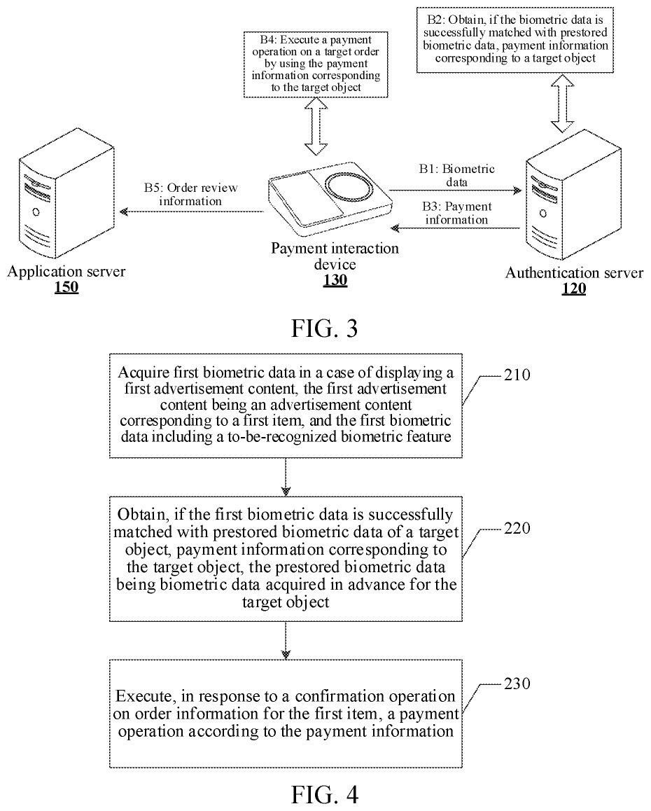

The method provided in this application may be applied to an implementation environment shown in FIG. 1. The implementation environment includes a terminal 110 and an authentication server 120. The terminal 110 communicates with the authentication server 120 through a communication network. The communication network employs standard communication technologies and/or protocols. The communication network is typically the Internet, but may also be any network, including but not limited to a Bluetooth, a local area network (LAN), a metropolitan area network (MAN), a wide area network (WAN), a mobile network, a dedicated network, or any combination of virtual dedicated networks. In some embodiments, customized or dedicated data communication technologies may be used to replace or supplement the foregoing data communication technologies.

The terminal 110 involved in this application includes, but is not limited to, a digital signage, a palm scanning device (that is, a device that can recognize palm prints and provide functions such as payment and authentication), a face scanning device (that is, a device that can recognize human faces and provide functions such as payment and authentication), a mobile phone, a tablet computer, a notebook computer, a desktop computer, an intelligent speech interaction device, a virtual reality device, an intelligent home appliance, an on board terminal, an aircraft, and the like. A client is deployed on the terminal 110. The client may run on the terminal 110 in a form of a browser, or may run on the terminal 110 in a form of an independent application (APP), a mini program, or the like.

The authentication server 120 involved in this application may be an independent physical server, or a server cluster or a distributed system including a plurality of physical servers, or may alternatively be a cloud server that provides basic cloud computing services, such as cloud service, cloud database, cloud computing, cloud function, cloud storage, network service, cloud communication, middleware service, domain name service, security service, content delivery network (CDN), and big data and artificial intelligence (AI) platform.

With reference to the foregoing implementation environment, in operation K1, a terminal 110 plays advertisement contents of items. In operation K2, the terminal 110 transmits acquired biometric data to an authentication server 120. In operation K3, the authentication server 120 matches the biometric data with prestored biometric data in a database, and obtains, if the biometric data is successfully matched with a piece of prestored biometric data, payment information corresponding to a target object. In operation K4, the authentication server 120 transmits payment information and recipient information to the terminal 110. In operation K5, the terminal 110 locks, after acquiring the biometric data, the currently played advertisement, and displays order information for the item. The terminal 110 executes, if the user triggers a confirmation operation on the order information, a payment operation by using the payment information.

Exemplarily, in a specific application scenario, the terminal 110 may be a payment interaction device 130. The payment interaction device 130 communicates with an advertisement display device 140 through a communication network. The payment interaction device 130 involved in this application includes, but is not limited to, a palm scanning device (that is, a device that can recognize palm prints and provide functions such as payment and authentication), a face scanning device (that is, a device that can recognize human faces and provide functions such as payment and authentication), and the like.

The advertisement display device 140 involved in this application is a device (for example, a digital signage) configured to display advertisement contents in public places. The advertisement contents may be updated and transmitted in real time through network connection. The advertisement display device supports remote management and control. Prestored advertisement contents may also be played. For example, advertisement materials are stored in a mode such as a universal serial bus (USB) interface, a memory card, or an internal memory, and are displayed on a display screen. In addition, the advertisement display device 140 may further implement interaction functions, such as a touchscreen and speech recognition, to provide more diversified user experience.

With reference to the foregoing implementation environment, in operation A1, an advertisement display device 140 plays advertisement contents of items. In operation A2, a payment interaction device 130 transmits acquired biometric data to an authentication server 120. In operation A3, the authentication server 120 matches the biometric data with prestored biometric data in a database, and obtains, if the biometric data is successfully matched with a piece of prestored biometric data, payment information corresponding to a target object. In operation A4, the authentication server 120 transmits the payment information to the payment interaction device 130. In operation A5, the payment interaction device 130 transmits, after acquiring the biometric data, an advertisement lock request to the advertisement display device 140. In operation A6, the advertisement display device 140 feeds back a lock response message to the payment interaction device 130. In operation A7, the payment interaction device 130 transmits, based on an item identity document and the payment information that are carried in the lock response message, an order placement request to the advertisement display device 140. In operation A8, the advertisement display device 140 displays, according to the order placement request, order information for the item. In operation A9, the advertisement display device 140 executes, if the user triggers a confirmation operation on the order information, a payment operation by using the payment information.

Exemplarily, in a specific application scenario, a terminal 110 may be the payment interaction device 130. The payment interaction device 130 communicates with an application server 150 through a communication network.

The application server 150 involved in this application may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a CDN, and big data and artificial intelligence (AI) platform.

With reference to the foregoing implementation environment, in operation B1, a payment interaction device 130 transmits acquired biometric data to an authentication server 120. In operation B2, the authentication server 120 matches the biometric data with prestored biometric data in a database, and obtains, if the biometric data is successfully matched with a piece of prestored biometric data, payment information corresponding to a target object. In operation B3, the authentication server 120 transmits the payment information to the payment interaction device 130. In operation B4, the payment interaction device 130 performs a payment operation on an order by using the payment information. In operation B5, the payment interaction device 130 generates, based on speech information, order review information in a case of successful payment, and transmits the order review information to an application server 150.

With reference to the foregoing descriptions, the service processing method in this application is described below. Referring to FIG. 4, the service processing method in this embodiment of this disclosure may be independently completed by a payment interaction module, or may be completed by the payment interaction module in cooperation with a server. The method of this application includes:

210: Acquire first biometric data in a case of displaying a first advertisement content, the first advertisement content being an advertisement content corresponding to a first item, and the first biometric data including a to-be-recognized biometric feature.

In one or more embodiments, when the terminal displays an advertisement content for a first item (that is, a first advertisement content) by using an advertisement display module, first biometric data may be acquired. A bidirectional communication connection is established between the advertisement display module and the payment interaction module in a wired or wireless mode. When delivering the advertisement content, the advertisement display module further needs to obtain an order placement link, an amount, and the like of the corresponding item.

Specifically, the first biometric data includes a to-be-recognized biometric feature. Exemplarily, assuming that the first biometric data is a palm image, the to-be-recognized biometric feature is palm prints. Assuming that the first biometric data is a human face image, the to-be-recognized biometric feature is a human face. Assuming that the first biometric data is speech data, the to-be-recognized biometric feature is voiceprints.

The terminal involved in this application includes the advertisement display module and the payment interaction module. The advertisement display module and the payment interaction module may be software modules of the terminal (that is, a module having an advertisement playback function is the advertisement display module, and a module having a biometric payment function is the payment interaction module), or may be hardware modules of the terminal (that is, the advertisement display module may be an advertisement display device, and the payment interaction module may be a payment interaction device).

220: Obtain, if the first biometric data is successfully matched with prestored biometric data, payment information corresponding to a target object, the prestored biometric data being biometric data acquired in advance for the target object.

In one or more embodiments, the acquired first biometric data needs to be recognized. In one case, the payment interaction module locally stores a plurality of pieces of prestored biometric data. Based on this, the payment interaction module may match the first biometric data with each piece of prestored biometric data locally stored in the terminal. In another case, the payment interaction module transmits the first biometric data to the authentication server, and the authentication server stores a plurality of pieces of prestored biometric data. Based on this, the authentication server may match the first biometric data with each piece of prestored biometric data locally stored.

In a possible implementation, the first item needs to be provided to the target object only by way of mailing. Therefore, when the payment information corresponding to the target object is obtained, recipient information, which includes at least one of a mailing address and account information, may further be obtained at the same time, so as to obtain the first item by using the recipient information.

Specifically, for ease of understanding, an example in which the first biometric data and the prestored biometric data are both palm print images is used. Referring to Table 1, Table 1 illustrates a schematic representation of the correspondence between the prestored biometric data and objects.

TABLE 1

| Prestored biometric | | Payment | Recipient |
|---|---|---|---|
| data | Objects | information | information |
| Palm print image 1 | User A | XXX | XXXXX |
| Palm print image 2 | User B | XXX | XXXX |
| Palm print image 3 | User C | XXX | XXX |
| Palm print image 4 | User D | XXX | XXXXXX |

Assuming that the similarity between the first biometric data and the palm print image 3 is the largest and the similarity is greater than a threshold (for example, 95%), then the first biometric data is successfully matched with the palm print image 3. Therefore, “User C” is used as the target object, and payment information and recipient information that correspond to the target object may be obtained.

The payment information may specifically be payment code information. The payment information includes, but is not limited to, a payment platform, a user identity document (ID), a payment mode, and a dynamic payment password. The payment platform is a third-party service intermediary, and has an escrow payment function. The user ID is configured for uniquely identifying a user. The payment mode indicates information about the payment mode used by the user, for example, a bank card or a balance. The dynamic payment password is automatically updated at regular intervals.

230: Execute, in response to a confirmation operation on order information for the first item, a payment operation according to the payment information.

In one or more embodiments, the payment interaction module transmits a first order placement request to the advertisement display module. The first order placement request carries the payment information, the recipient information (exemplary), and the identity document of the first item. Based on this, the advertisement display module may generate the order information for the first item according to the recipient information and the identity document of the first item, and execute the payment operation by using the payment information.

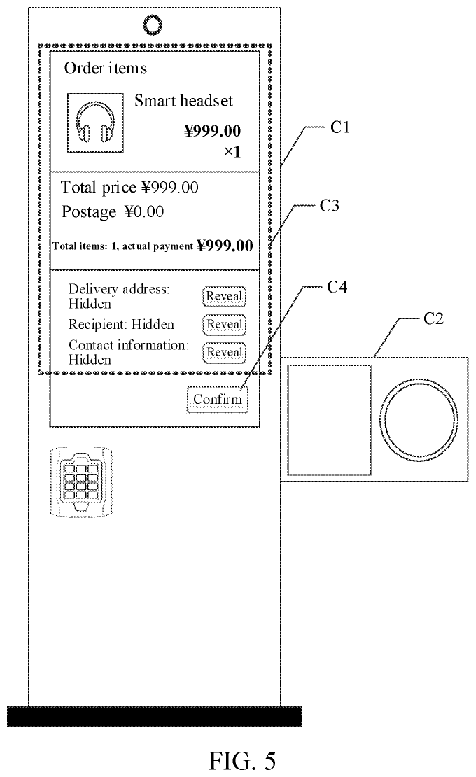

Exemplarily, for ease of understanding, referring to FIG. 5, FIG. 5 is a schematic diagram of confirming order information according to an embodiment of this disclosure. As shown in the figure, C1 is configured for indicating the advertisement display module. C2 is configured for indicating the payment interaction module. C3 is configured for indicating the order information for the first item. The order information includes, but is not limited to, a to-be-paid amount, item information, a delivery address, and the like. Considering user privacy, delivery information may be hidden, and when the user taps a display control, corresponding information may be displayed. C4 is configured for indicating a confirmation control. When the user taps the confirmation control indicated by C4, a confirmation operation for the order information is triggered, so that the terminal (that is, the advertisement display module or the payment interaction module) may execute the payment operation according to the payment information.

“In response to” involved in this application is configured for indicating a condition or status on which an operation to be performed depends. When the condition or status is met, one or more operations may be executed. These operations may be in real time, or may have a delay.

For the foregoing implementation of also obtaining the recipient information in operation 220, when the payment operation is executed in operation 230, in a possible implementation, the recipient information is an address for receiving the first item in a case of successful payment.

In this embodiment of this disclosure, the service processing method is provided. In the foregoing mode, when viewing the advertisement content on the terminal, the user may directly place an order to purchase the item by way of biometric payments. This application not only saves operation time and energy and improves order placement efficiency, but also helps to promote item sales, thereby improving an advertising value.

In some embodiments, based on one or more embodiments corresponding to FIG. 4 described above, in another exemplary embodiment provided in this embodiment of this disclosure, after the first biometric data is acquired, the method may further include:
transmitting an advertisement lock request to an advertisement display module by using a payment interaction module, to generate a lock response message by using the advertisement display module, the lock response message carrying an identity document of the first item; and
receiving the lock response message transmitted by the advertisement display module by using the payment interaction module;
or
locking the first advertisement content in response to the advertisement lock request.

In one or more embodiments, a mode of locking the first advertisement content is described. As can be known from the foregoing embodiment, when viewing the first advertisement content on the terminal, the user (for example, the target object) may further scan the biometric feature (for example, palm prints) by using the payment interaction module, so as to rapidly place an order and make payment.

Specifically, to prevent the user from being unable to place an order for the first item due to another advertisement content displayed on the terminal, when the first biometric data is acquired, the payment interaction module may transmit the advertisement lock request to the advertisement display module. When receiving the advertisement lock request, the advertisement display module immediately locks the first advertisement content that is currently played. Thereby, the advertisement display module transmits a lock response message to the payment interaction module. The lock response message carries the identity document of the first item. Based on this, the payment interaction module performs subsequent order placement according to the identity document of the first item.

The terminal may lock the first advertisement content according to the advertisement lock request. The mode of locking specifically includes the following:

When locking the first advertisement content based on the advertisement lock request, the terminal suspends playback of the first advertisement content. When the lock is undone, the terminal may continue to display the first advertisement content.

Alternatively, when locking the first advertisement content based on the advertisement lock request, the terminal displays the first advertisement content in cycles. When the lock is undone, the terminal may play another advertisement content (for example, a second advertisement content).

In addition, in this embodiment of this disclosure, a mode of locking the first advertisement content is provided. In the foregoing mode, when the first biometric data is acquired, the payment interaction module requests the advertisement display module to lock the first advertisement content. Thereby, the user can place an order for the specified item (that is, the first item), so as to avoid incorrect order placement.

In some embodiments, based on one or more embodiments corresponding to FIG. 4 described above, in another exemplary embodiment provided in this embodiment of this disclosure, after the first biometric data is acquired, the method may further include:

transmitting an advertisement lock request to an advertisement display module by using a payment interaction module, to continuously display the first advertisement content within a preset duration by using the advertisement display module.

If no biometric data is acquired within the preset duration, in a case that the preset duration ends, a second advertisement content is displayed. The second advertisement content is an advertisement content corresponding to a second item.

If third biometric data is acquired within the preset duration and the third biometric data is successfully matched with first prestored biometric data of a first object, first payment information corresponding to the first object is obtained, and an order information for the first item related to the first object is displayed.

In one or more embodiments, a mode of displaying the advertisement content based on the advertisement lock request is described. As can be known from the foregoing embodiment, when the first biometric data is acquired, the terminal may transmit the advertisement lock request to the advertisement display module by using the payment interaction module such that the advertisement display module performs corresponding processing based on the advertisement lock request.

Specifically, when receiving the advertisement lock request, the advertisement display module continuously displays the first advertisement content within a preset duration (for example, 1 minute). If the remaining playback duration of the first advertisement content is less than the preset duration, the first advertisement content is replayed after being played, that is, the advertisement display module plays the first advertisement content in cycles until the preset duration ends. If the remaining playback duration of the first advertisement content is greater than or equal to the preset duration, the advertisement display module continues to play the first advertisement content.

If no other biometric data is acquired within the preset duration, no other user (relative to the target object) intends to place an order for the first item within the preset duration. Therefore, after the preset duration ends, the advertisement display module switches to another advertisement content for display, that is, displays the second advertisement content corresponding to the second item. If other biometric data, such as third biometric data (or third biometric feature, third biometric feature data), is acquired within the preset duration, another user also intends to place an order for the first item. Therefore, the preset duration is re-recorded when the other biometric data is acquired. In addition, when the third biometric data is successfully matched with the first prestored biometric data of the first object, the first payment information corresponding to the first object is obtained, and the order information for the first item related to the first object is displayed. That is, in a process of purchasing the first item by the target object, a purchase service for the first item may also be simultaneously or sequentially provided to the first object.

In addition, in this embodiment of this disclosure, a mode of displaying advertisement content based on the advertisement lock request is provided. In the foregoing mode, when the first advertisement content is locked, the terminal may further continuously display the first advertisement content within the preset duration. Thereby, another user also has enough time to place an order for the first item, so as to improve user experience.

In some embodiments, based on one or more embodiments corresponding to FIG. 4 described above, in another exemplary embodiment provided in this embodiment of this disclosure, after the first biometric data is acquired, the method may further include:
transmitting an advertisement lock request to an advertisement display module by using a payment interaction module, to provide a queuing control by using the advertisement display module when the first advertisement content is displayed;
displaying the first advertisement content continuously if a response to a selection operation on the queuing control is received; and
displaying a second advertisement content if no response to a selection operation on the queuing control is received in a case that display of the first advertisement content is completed, the second advertisement content being an advertisement content corresponding to a second item.

In one or more embodiments, another mode of displaying the advertisement content based on the advertisement lock request is described. As can be known from the foregoing embodiment, when the first biometric data is acquired, the terminal transmits the advertisement lock request to the advertisement display module by using the payment interaction module, such that the advertisement display module performs corresponding processing based on the advertisement lock request.

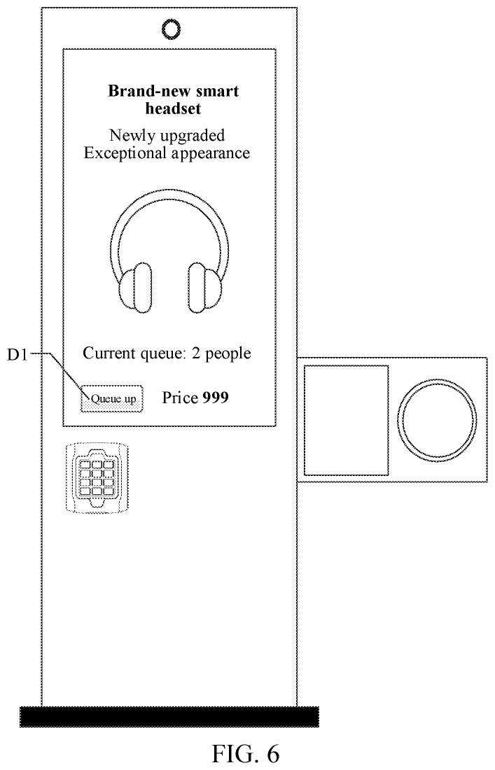

Specifically, when receiving the advertisement lock request, the advertisement display module provides the queuing control when displaying the first advertisement content. Based on this, another user may queue up for the target object to complete the order placement operation on the first item. For ease of description, referring to FIG. 6, FIG. 6 is a schematic diagram of queuing up to place an order according to an embodiment of this disclosure. As shown in the figure, D1 is configured for indicating the queuing control. When the user taps the queuing control, a selection operation on the queuing control is triggered. Thereby, the advertisement display module continues to display the first advertisement content (for example, replays the first advertisement content). If no user queues up to purchase the first item after display of the first advertisement content is completed, the advertisement display module switches to another advertisement content for display, that is, displays the second advertisement content corresponding to the second item.

In addition, in this embodiment of this disclosure, another mode of displaying the advertisement content based on the advertisement lock request is provided. In the foregoing mode, the terminal displays the queuing control based on the advertisement lock request, so that another user can queue up to place an order for the first item. Therefore, an advertisement playback time and an order placement time of a user are well balanced, so as to improve an advertisement playback effect.

In some embodiments, based on one or more embodiments corresponding to FIG. 4 described above, in another exemplary embodiment provided in this embodiment of this disclosure, the method may further include:
acquiring second biometric data in a case that an item information set is displayed, the item information set being at least one piece of item information recommended based on a face recognition result, and the second biometric data including a to-be-recognized biometric feature;
obtaining payment information and recipient information that correspond to the target object if a response to an order placement operation for a third item is received and the second biometric data is successfully matched with the prestored biometric data, the third item being an item corresponding to target item information, and the target item information being one piece of item information in the item information set; and
transmitting an order placement request by using a payment interaction module, to display order information for the third item by using an advertisement display module, the order placement request carrying the payment information, the recipient information, and an identity document of the third item, and the recipient information being an address also for receiving the third item in a case of successful payment.

The order placement request may be transmitted to the advertisement display module, or may be transmitted to a merchant server or a payment server. This is not limited in this application.

In one or more embodiments, a mode of recommending the item information based on the face recognition result is described. As can be known from the foregoing embodiment, in a case that the user (for example, the target object) agrees to authorize the terminal to acquire the face image, the face image of the user may further be obtained by using an image acquisition apparatus, and the acquired face image is matched with prestored face images to obtain the face recognition result. If the face recognition result indicates successful face recognition, a historical shopping record of the user is obtained based on a recognized user ID, so that an item information set that the user is interested in is recommended to the user.

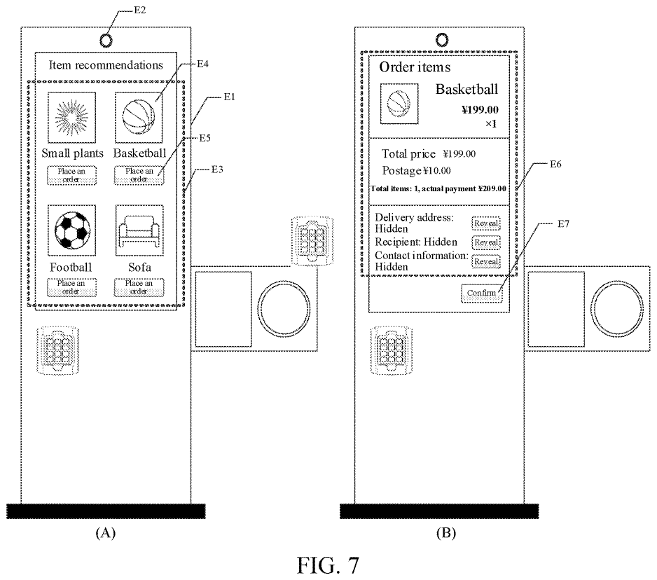

Specifically, for ease of understanding, referring to FIG. 7, FIG. 7 is a schematic diagram of recommending an item information set according to an embodiment of this disclosure. As shown in (A) in FIG. 7, an image acquisition apparatus (for example, a camera) indicated by E2 is provided on the advertisement display module indicated by E1. E3 is configured for indicating an item information set (for example, including 4 pieces of recommended item information). E4 is configured for indicating target item information, and the user may view details (such as price, specification, and review) of the corresponding item (that is, the third item) by tapping the target item information. E5 is configured for indicating an order placement control for the third item. When the user taps the order placement control indicated by E8, an order placement operation on the third item is triggered.

Assuming that the target object intends to purchase the third item, the second biometric data may be uploaded by using the payment interaction module. In a case that the second biometric data is successfully matched with the prestored biometric data, the payment interaction module transmits an order placement request to the advertisement display module. The order placement request carries the payment information of the target object, the recipient information of the target object, and the identity document of the third item. Based on this, as shown in (B) in FIG. 7, E6 is configured for indicating the order information for the third item. E7 is configured for indicating a confirmation control. When the user taps the confirmation control indicated by E7, a confirmation operation on the order information is triggered, so that the terminal (that is, the payment interaction module or the advertisement display module) may perform a payment operation according to the payment information.

In one case, the user may first select any piece of item information from the item information set as the target item information, and trigger an order placement operation on the target item information, and then acquire biometric data by using the payment interaction module. In another case, the user may first acquire biometric data by using the payment interaction module, then select any piece of item information from the item information set as the target item information, and trigger an order placement operation on the target item information. This is not limited herein.

In an actual application, the user may also select a plurality of pieces of item information from the item information set to place an order. This embodiment is described in an example of “target item information”, but does not constitute a limitation to this application.

In addition, in this embodiment of this disclosure, a mode of recommending item information based on the face recognition result is provided. In the foregoing mode, the face recognition function is added to the terminal, so that item information meeting user requirements can be recommended according to the face recognition result. Therefore, an exposure rate of the item can be improved, so that it is convenient for the user to place an order for the item.

In some embodiments, based on one or more embodiments corresponding to FIG. 4 described above, in another exemplary embodiment provided in an embodiment of this disclosure, the executing, in response to a confirmation operation on order information for the first item, a payment operation according to the payment information may specifically include:
obtaining a speech instruction by using a speech input apparatus; and
executing, in a case that the speech instruction meets an instruction trigger condition, the payment operation according to the payment information in response to the confirmation operation on the order information for the first item, where
the case that the instruction trigger condition is met includes at least one of the following:
after recognizing the speech instruction, it is determined that a text instruction corresponding to the speech instruction includes a trigger word; and
after recognizing the speech instruction, it is determined that an initiator of the speech instruction is the target object.

In one or more embodiments, a mode of triggering the confirmation operation based on the speech instruction is described. As can be known from the foregoing embodiment, in a case that the user agrees to authorize the terminal to acquire a speech, the terminal may further obtain a speech instruction of the user by using a speech input apparatus (for example, an internal microphone or an external microphone), and determine whether the speech instruction meets an instruction trigger condition. If the instruction trigger condition is met, the confirmation operation on the order information is triggered. If the instruction trigger condition is not met, the terminal may display a related prompt message.

Exemplarily, the terminal may invoke an automatic speech recognition (ASR) model to recognize the content of the speech instruction, thereby converting the speech instruction into a text instruction (that is, an instruction in a text form). Based on this, whether the text instruction includes a trigger word needs to be detected. The trigger word may be “place an order”, “confirm”, and the like. This is not limited herein. Configuration of the ASR model may be deployed on a terminal, configuration of the ASR model may be deployed on a server, or configuration of the ASR model is partially deployed on a terminal and partially deployed on a server. This is not limited herein.

Exemplarily, in one case, the terminal locally stores a plurality of pieces of prestored speech data. Based on this, the terminal may match the speech instruction with each piece of prestored speech data locally stored. In another case, the terminal may upload an acquired speech instruction to the authentication server, or the terminal uploads the acquired speech instruction to the authentication server. The authentication server locally stores a plurality of pieces of prestored speech data. Based on this, the authentication server may match the speech instruction with each piece of prestored speech data locally stored. Assuming that the similarity between the speech instruction and the prestored speech data of the target object is the largest and the similarity is greater than a threshold (for example, 95%), then the speech instruction is successfully matched with the prestored speech data of the target object. Therefore, it is determined that the initiator of the speech instruction is the target object.

In addition, in this embodiment of this disclosure, a mode of triggering the confirmation operation based on the speech instruction is provided. In the foregoing mode, the speech recognition function is added to the terminal, so that the confirmation operation on the order information can be triggered according to the speech recognition result. Thereby, the user does not need to touch the screen or keys of the terminal, so as to reduce, to some extent, cross-infection caused by contact with infectious diseases, and improve the public health protection level.

In some embodiments, based on one or more embodiments corresponding to FIG. 4 described above, in another exemplary embodiment provided in this embodiment of this disclosure, the order information further includes a purchase quantity.

The method may further include:
obtaining target text information by using at least one of a touchscreen, physical keys, or projection keys; and
determining a purchase quantity according to the target text information.

Alternatively, the method may further include:
obtaining target speech information by using a speech input apparatus; and
determining a purchase quantity according to the target speech information.

In one or more embodiments, a mode of inputting the purchase quantity is described. As can be known from the foregoing embodiment, before confirming to place an order, the user (for example, the target object) may further modify the purchase quantity of the item (for example, the first item) by inputting a text or inputting a speech. Modes of inputting a text and inputting a speech are respectively described below.

### 1. Text-Based Input.

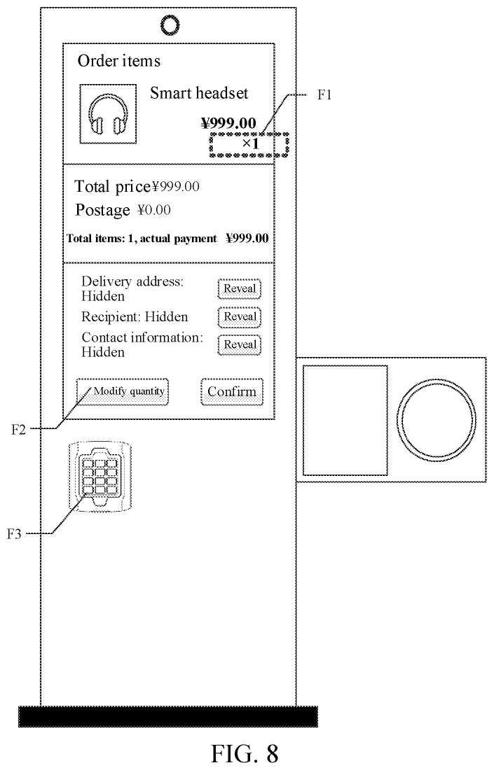

Specifically, for ease of understanding, referring to FIG. 8, FIG. 8 is a schematic diagram of determining a purchase quantity according to an embodiment of this disclosure. As shown in the figure, F1 is configured for indicating a default purchase quantity (for example, 1). F2 is configured for indicating a quantity modification control. F3 is configured for indicating physical keys. When the user taps the quantity modification control indicated by F2, the target text information may be inputted by using a touchscreen, physical keys, or projection keys. Assuming that the target text information is “2”, then the purchase quantity is “2 items”.

For the projection keys, an outline of a standard keyboard may be projected on any surface by using a built-in laser device, then actions of a finger may be captured by using an infrared technology, and finally inputted information is obtained.

### 2. Speech-Based Input.

Specifically, in a case that the user agrees to authorize the terminal to acquire a speech, the terminal may further obtain target speech information by using a speech input apparatus (for example, a microphone). Then, an ASR model is invoked to recognize the target speech information, to obtain text information. Assuming that the text information includes “2”, then the purchase quantity is “2 items”.

In addition, in this embodiment of this disclosure, a mode of inputting the purchase quantity is provided. In the foregoing mode, the user may further modify the purchase quantity during order placement. Therefore, if the user needs to place an order for a plurality of items, the order placement operation may be completed at a time. Therefore, convenience of operation is improved.

In some embodiments, based on one or more embodiments corresponding to FIG. 4 described above, in another exemplary embodiment provided in this embodiment of this disclosure, the method may further include:
transmitting, in a case of failed payment, item information for the first item to a target terminal used by the target object, the target terminal being configured to display the item information for the first item.

In one or more embodiments, a mode of pushing a failed order to the target terminal is described. As can be known from the foregoing embodiment, failed payment may occur to the user (for example, the target object) in a payment process. For example, the failed payment may occur due to an insufficient balance of the account, a network problem, an unusual activity on the account, or the like.

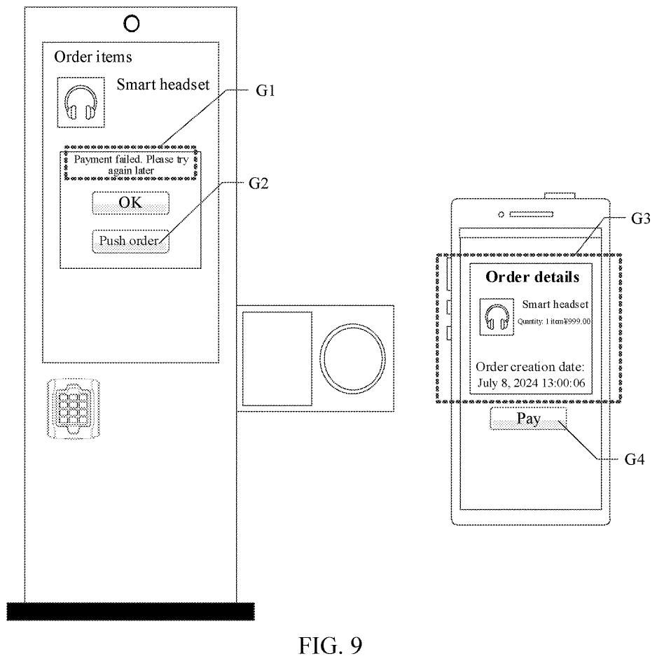

Specifically, for ease of understanding, referring to FIG. 9, FIG. 9 is a schematic diagram of implementing order placement at a terminal based on a failed payment message according to an embodiment of this disclosure. As shown in the figure, G1 is configured for indicating the failed payment message. G2 is configured for indicating an order push control. When the user taps the order push control indicated by G2, the advertisement display module may request the server to transmit the item information for the first item to the terminal used by the user (that is, the target object). Based on this, the item information indicated by G3 and a payment control indicated by G4 are displayed on the target terminal. When the user taps the payment control indicated by G4, an order placement operation may be performed by using the target terminal.

In addition, in this embodiment of this disclosure, a mode of pushing a failed order to the target terminal is provided. In the foregoing mode, in a case of failed payment for the order, the order may further be pushed to the target terminal used by the user, so that the user make payment based on the order. Therefore, on one hand, it is convenient for the user to place an order again according to needs, so as to improve payment flexibility. On the other hand, for the merchant, the order loss rate may be reduced, thereby helping to promote more transactions.

In some embodiments, based on one or more embodiments corresponding to FIG. 4 described above, in another exemplary embodiment provided in this embodiment of this disclosure, the mailing address is a default recipient address preset by using the terminal, and the account information is an account associated with the target object.

In a case that the first item is a physical item, the recipient information is the mailing address.

In a case that the first item is a virtual item, the recipient information is the account information.

In one or more embodiments, an item-type-based delivery mode is described. As can be known from the foregoing embodiment, the first item may be a physical item (for example, a headset or a basketball), or may be a virtual item (for example, mobile recharge or game vouchers). Based on this, corresponding recipient information is used for different types of items.

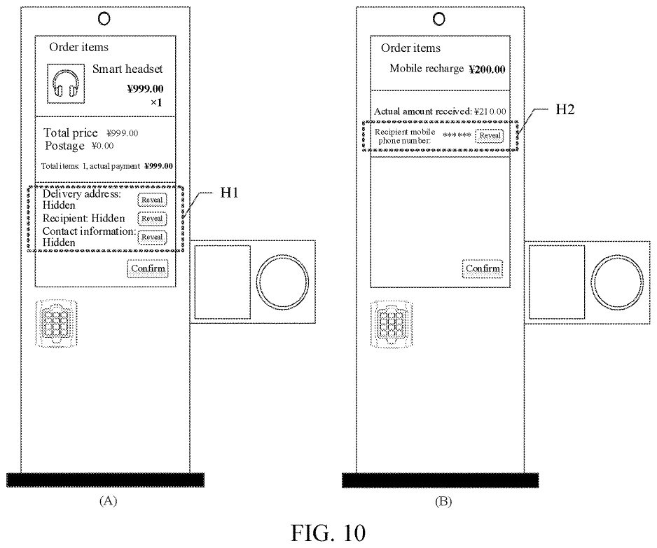

Specifically, for ease of understanding, referring to FIG. 10, FIG. 10 is a schematic diagram of implementing delivery of different types of items according to an embodiment of this disclosure. As shown in (A) in FIG. 10, H1 is configured for indicating the mailing information (for example, mailing address, recipient name, and recipient contact information). Assuming that the first item is a physical item (for example, a smart headset), after the user places an order and make payment successfully, the first item may be mailed to the mailing address preset by the user. As shown in (B) in FIG. 10, H2 is configured for indicating the account information (for example, mobile phone number). Assuming that the first item is a virtual item (for example, mobile recharge), after the user places an order and make payment successfully, the first item may be credited to the account of the user.

In addition, in this embodiment of this disclosure, an item-type-based delivery mode is provided. In the foregoing mode, the physical item may be mailed to the address provided by the user. The virtual item may be directly credited to the corresponding account. Thereby, diversity and flexibility of item transactions are improved.

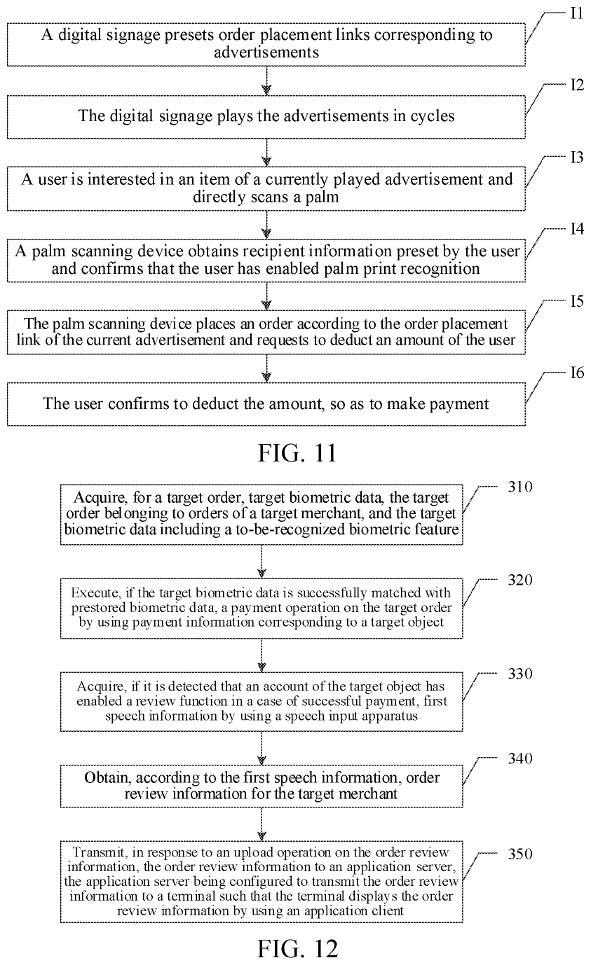

Based on the embodiments corresponding to FIG. 4, the following describes an overall flow with reference to FIG. 10. Referring to FIG. 11, FIG. 11 is a schematic flowchart of an application of a service processing method according to an embodiment of this disclosure. As shown in the figure, specifically:
In operation I1, an advertisement display module sets order placement links of advertisements such that an order for an item of an advertisement can be placed based on the order placement link.
In operation I2, the advertisement display module plays the advertisements in cycles.
In operation I3, a user is interested in a currently played advertisement and directly scans a palm by using a palm scanning device.
In operation I4, the palm scanning device obtains, in a case that it is confirmed that the palm scanning user has enabled palm print recognition, recipient information preset by the user.
In operation I5, the palm scanning device places an order according to the order placement link of the current advertisement and requests to deduct an amount of the user.
In operation I6, the user confirms to deduct the amount, so as to make payment.

Based on one or more embodiments corresponding to FIG. 4 described above, an embodiment of this disclosure provides another exemplary embodiment. Referring to FIG. 12, the service processing method in this embodiment of this disclosure may be independently completed by a payment interaction device, or may be completed by the payment interaction device in cooperation with a server. The embodiment corresponding to FIG. 12 may also be used as an independent embodiment. The method of this application includes:

310: Acquire, for a target order, target biometric data, the target order belonging to orders of a target merchant, and the target biometric data including a to-be-recognized biometric feature.

In one or more embodiments, after the target order is generated, the user needs to make payment. Based on this, the payment interaction device may acquire the target biometric data (for example, a palm image, a face image, a fingerprint image, an iris image, or speech data). As can be seen, the target biometric data includes a to-be-recognized biometric feature (such as palm prints, a human face, fingerprints, irises, or voiceprints). The target order is an order of a target merchant (for example, a restaurant, a convenience store, or a supermarket).

320: Execute, if the target biometric data is successfully matched with prestored biometric data, a payment operation on the target order by using payment information corresponding to a target object.

In one or more embodiments, the acquired target biometric data needs to be recognized. In one case, the payment interaction device locally stores a plurality of pieces of prestored biometric data. Based on this, the payment interaction device may match the target biometric data with each piece of prestored biometric data locally stored. In another case, the payment interaction device transmits the target biometric data to the authentication server, and the authentication server locally stores a plurality of pieces of prestored biometric data. Based on this, the authentication server may match the target biometric data with each piece of prestored biometric data locally stored.

For a matching process, reference may be made to operation 220 in the foregoing embodiment, and details are not described herein again. Assuming that the target biometric data is successfully matched with the prestored biometric data of the target object, then it is determined that the user is the target object. Thereby, the payment information (for example, a payment platform, a user ID, a payment mode, and a dynamic payment password) corresponding to the target object may be obtained, such that a payment operation on the target order is executed.

330: Acquire, if it is detected that an account of the target object has enabled a review function in a case of successful payment, first speech information by using a speech input apparatus.

In one or more embodiments, in a case of successful payment, whether the account (for example, an account of a review application) that the target object currently logs in has enabled the review function is queried. If the review function has been enabled, the payment interaction device may acquire the first speech information by using the speech input apparatus (for example, an internal microphone or an external microphone).

340: Obtain, according to the first speech information, order review information for the target merchant.

In one or more embodiments, in one mode, the payment interaction device may invoke an ASR model to recognize the first speech information, so as to obtain the order review information. In another mode, the payment interaction device transmits the first speech information to the server, and the server invokes an ASR model to recognize the first speech information, so as to obtain the order review information.

Configuration of the ASR model may be deployed on the payment interaction device, configuration of the ASR model may be deployed on the server, or configuration of the ASR model is partially deployed on the payment interaction device and partially deployed on the server. This is not limited herein.

350: Transmit, in response to an upload operation on the order review information, the order review information to an application server, the application server being configured to transmit the order review information to a target terminal such that the target terminal displays the order review information by using an application client.

In one or more embodiments, the user may choose to upload the order review information, and the payment interaction device uploads the order review information to an application server (for example, a server of the review application). Based on this, the application client (for example, a client of the review application) may display the order review information. In addition, if the user presets a public nickname, a real name, or an avatar, the application client may further display information (for example, the nickname, the real name, and the avatar) of the user transmitting the order review information.

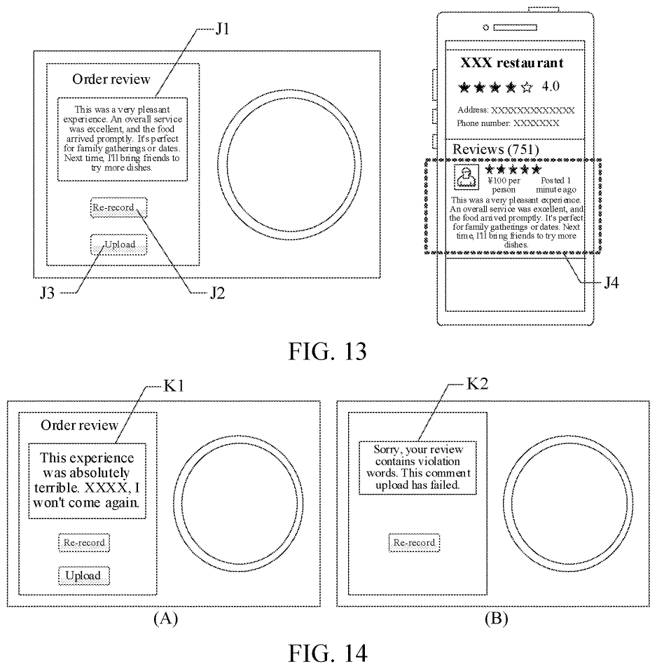

Specifically, for ease of understanding, referring to FIG. 13, FIG. 13 is a schematic diagram of uploading order review information according to an embodiment of this disclosure. As shown in the figure, J1 is configured for indicating the order review information. J2 is configured for indicating a re-recording control. J3 is configured for indicating an upload control. When the user taps the re-recording control indicated by J2, the speech information may be re-recorded, to generate new order review information. When the user taps the upload control indicated by J3, an upload operation on the order review information is triggered, and thereby, the payment interaction device transmits the order review information to the application server. Based on this, review information for the target merchant may be viewed or heard in the application client. J4 is configured for indicating the order review information displayed in the application client.

In addition, in this embodiment of this disclosure, a mode of reviewing in a transaction process is provided. In the foregoing mode, the speech input function is added to the payment interaction device, so that when the user makes transactions, user information is recognized, and speech reviews of the user are recorded. Thereby, the order review information is directly generated based on the speech reviews, to prevent the user from manually opening software for reviewing, so as to improve comment efficiency and increase credibility of reviews.

In some embodiments, based on one or more embodiments corresponding to FIG. 12 described above, in another exemplary embodiment provided in an embodiment of this disclosure, the obtaining, according to the first speech information, order review information for the target merchant may specifically include:
recognizing the first speech information to obtain to-be-processed text information; and
using, if the to-be-processed text information does not include any violation words, the first speech information as the order review information for the target merchant.

The method may further include:
displaying, if the to-be-processed text information includes at least one violation word, a notification message indicating comment failed.

In one or more embodiments, a mode of generating the order review information is described. As can be known from the foregoing embodiment, after the first speech information is acquired, the to-be-processed text information may be obtained by invoking the ASR model. Based on this, the to-be-processed text information may be detected, and in a case that no violation word is included, the first speech information may be directly used as the order review information for the target merchant. That is, the order review information may be played in a form of a speech. That is, when the speech information is used as the order review information, the target terminal may play the order review information by using the application client.

Specifically, for ease of understanding, referring to FIG. 14, FIG. 14 is a schematic diagram of displaying a notification message indicating comment failed according to an embodiment of this disclosure. As shown in (A) in FIG. 14, K1 is configured for indicating the to-be-processed text information. It is assumed that the to-be-processed text information includes violation words. Based on this, after the user taps the upload control, an interface shown in (B) in FIG. 14 is displayed. K2 is configured for indicating a notification message indicating comment failed.

Moreover, in this embodiment of this disclosure, a mode of generating the order review information is provided. In the foregoing mode, the speech inputted by the user is converted into the corresponding text, and the content of the text is automatically detected, to avoid occurrence of inappropriate contents in the speech. Thereby, compliance of speech reviews is improved.

In some embodiments, based on one or more embodiments corresponding to FIG. 12 described above, in another exemplary embodiment provided in an embodiment of this disclosure, the obtaining, according to the first speech information, order review information for the target merchant may specifically include:
recognizing the first speech information to obtain to-be-processed text information; and
using, if the to-be-processed text information does not include any violation words, the to-be-processed text information as the order review information for the target merchant.

The method may further include:
highlighting, if the to-be-processed text information includes at least one violation word, the at least one violation word.

In one or more embodiments, another mode of generating the order review information is described. As can be known from the foregoing embodiment, after the first speech information is acquired, the to-be-processed text information may be obtained by invoking the ASR model. Based on this, the to-be-processed text information may be detected, and in a case that no violation word is included, the to-be-processed text information may be used as the order review information for the target merchant. That is, the order review information may be displayed in a form of a text. That is, when the to-be-processed text information recognized from the speech information is used as the order review information, the target terminal may display the order review information by using the application client.

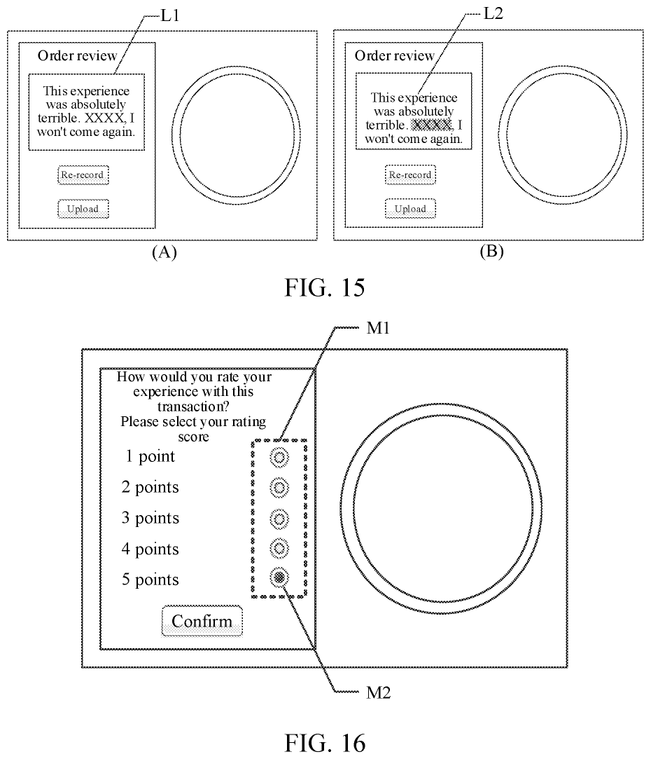

Specifically, for ease of understanding, referring to FIG. 15, FIG. 15 is a schematic diagram of highlighting violation words according to an embodiment of this disclosure. As shown in (A) in FIG. 15, K1 is configured for indicating the to-be-processed text information. It is assumed that the to-be-processed text information includes violation words. Based on this, after the user taps the upload control, an interface shown in (B) in FIG. 15 is displayed. L2 is configured for indicating highlighted violation words.

Moreover, in this embodiment of this disclosure, another mode of generating the order review information is provided. In the foregoing mode, the speech inputted by the user is converted into the corresponding text, and content of the text is automatically detected, to avoid occurrence of inappropriate contents in the text. Thereby, compliance of speech reviews is improved.

In some embodiments, based on one or more embodiments corresponding to FIG. 12 described above, in another exemplary embodiment provided in an embodiment of this disclosure, after the acquiring the first speech information by using the speech input apparatus, the method may further include:
performing emotion recognition on the first speech information to obtain an emotion recognition result; and
transmitting, if the emotion recognition result indicates that the first speech information is speech information with negative emotions, a discount application request to the application server, the discount application request carrying the account of the target object and an identity document of the target merchant, and the application server being configured to transmit an electronic coupon to the target terminal used by the target object.

In one or more embodiments, a mode of providing an electronic coupon based on an emotion recognition result is described. As can be known from the foregoing embodiment, when the user agrees to authorize the payment interaction device to acquire a speech, the first speech information may be analyzed based on a speech emotion recognition (SER) technology, to obtain an emotion recognition result.

SER refers to a technology of recognizing an emotion state of a speaker by using acoustic features of a segment of speech. A speaker may change acoustic features of a speech signal by adjusting actions of vocal organs, so as to express different emotions. Currently, emotion recognition models based on speech signals are primarily categorized into two types: a discrete emotion description model and a continuous emotion description model. The discrete emotion description model describes an emotion in a discrete and adjective label form, such as angry, happy, surprised, fearful, and sad. The continuous emotion description model describes an emotion as a point in a multi-dimensional emotional space, and each dimension in the space corresponds to a psychological attribute of the emotion. For example, in a two-dimensional space, an activation level indicates the intensity of emotion, and the valence indicates the positive or negative level of emotion. “Happy” may be represented by a high activation level and a high valence, and “sad” may be represented by a low activation level and a low valence.

Specifically, in one case, the payment interaction device performs emotion recognition on the first speech information. If the emotion recognition result indicates negative emotions, the payment interaction device may transmit a discount application request to the application server. The discount application request carries the account of the target object and an identity document of the target merchant. The application server may determine the user of the electronic coupon based on the account of the target object, and may determine the issuer of the electronic coupon based on the identity document of the target merchant. Based on this, the application server transmits the electronic coupon to the target terminal used by the target object. In another case, the payment interaction device transmits the first speech information to the application server, and the application server performs emotion recognition on the first speech information. If the emotion recognition result indicates negative emotions, the application server directly transmits the electronic coupon to the target terminal used by the target object.

In an actual application, the emotion recognition result may also be obtained by acquiring a conversation between the user and a shop assistant. The negative emotions include, but are not limited to, shame, guilt, indifference, sadness, fear, desire, anger, proudness, and the like.

Moreover, in this embodiment of this disclosure, a mode of providing an electronic coupon based on an emotion recognition result is provided. In the foregoing mode, if negative emotions of the user is recognized during transactions, the user receives an electronic coupon. Thereby, by responding to the negative emotions of the user promptly, user experience can be improved, and user stickiness can be enhanced.

In some embodiments, based on one or more embodiments corresponding to FIG. 12 described above, in another exemplary embodiment provided in this embodiment of this disclosure, the method may further include:
displaying, in a case of successful payment, K rating options for the target order, each rating option corresponding to one rating score, and K being an integer greater than 1; and
transmitting, in response to a selection operation on a target rating option, a rating score corresponding to the target rating option to the application server such that the application server updates a merchant score of the target merchant according to the rating score, the target rating option being one of the K rating options, and the application server being configured to transmit the merchant score to the target terminal such that the target terminal displays the merchant score by using the application client.

In one or more embodiments, a mode of scoring the target merchant is described. As can be known from the foregoing embodiment, the application client not only can display the comment content (for example, the order review information provided by the target object) for the target merchant, but also can display the merchant score of the target merchant. The merchant score of the merchant may affect purchasing decisions of the user, and a merchant with a high score usually attracts more consumers.

Specifically, for ease of understanding, referring to FIG. 16, FIG. 16 is a schematic diagram of displaying rating options according to an embodiment of this disclosure. As shown in the figure, after the payment is successful, the payment interaction device provides a plurality of rating options for the target order. M1 is configured for indicating 5 rating options (that is, in this case, K is equal to 5). As can be seen, each rating option corresponds to one rating score. For example, the first rating option corresponds to the rating score of 1, the second rating option corresponds to the rating score of 2, and so on.

Based on this, assuming that the user taps the rating option indicated by M2, the rating option is used as the target rating option. Based on this, the payment interaction device transmits the rating score (that is, 5) corresponding to the target rating option to the application server. The application server updates the merchant score of the target merchant based on the rating score. Thereby, the application client displays the updated merchant score in real time.

Moreover, in this embodiment of this disclosure, a mode of scoring the target merchant is provided. In the foregoing mode, after completing the payment operation on the target order, the user may further perform a scoring operation. Thereby, the user can be prevented from manually opening software for scoring, so as to improve scoring efficiency and increase credibility of scoring.

In some embodiments, based on one or more embodiments corresponding to FIG. 12 described above, in another exemplary embodiment provided in this embodiment of this disclosure, the method may further include:
displaying, if it is detected that the account of the target object has enabled the review function in a case of successful payment, M review objects corresponding to the target order, M being an integer greater than or equal to 1;
acquiring, in response to a selection operation on a target review object, second speech information by using the speech input apparatus, the target review object being one of the M review objects;
obtaining, according to the second speech information, object review information for the target review object; and
transmitting, in response to an upload operation on the object review information, the object review information to the application server, the application server being configured to transmit the object review information to the target terminal such that the target terminal displays the object review information by using the application client.

In one or more embodiments, a mode of commenting on objects in an order is described. As can be known from the foregoing embodiment, in a case of successful payment, if the account that the target object currently logs in has enabled the review function, overall reviewing may be performed on this transaction, and moreover, some objects (such as dishes, items, and service staff) involved in this transaction may be reviewed.

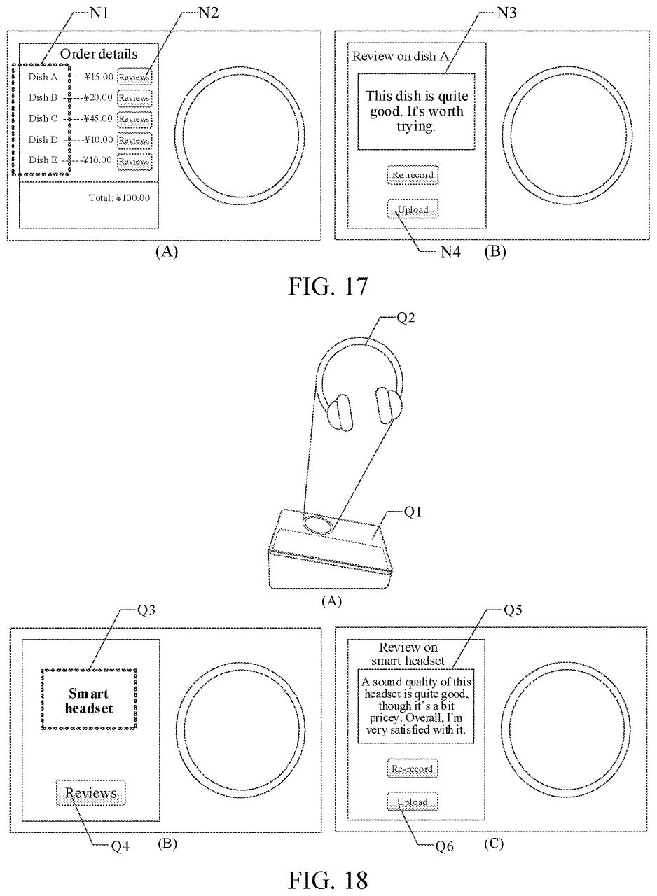

Specifically, for ease of understanding, referring to FIG. 17, FIG. 17 is a schematic diagram of uploading object review information according to an embodiment of this disclosure. As shown in (A) in FIG. 17, after the payment is successful, the payment interaction device provides a plurality of review objects corresponding to the target order. N1 is configured for indicating 5 review objects (that is, 5 dishes, and in this case, M is equal to 5). As can be seen, each review object corresponds to one review control. Based on this, assuming that the user taps the review control indicated by N2, then “Dish A” is used as the target review object, and thus, a selection operation on the target review object is triggered. Thereby, the payment interaction device may acquire the second speech information by using the speech input apparatus.

In one mode, the payment interaction device may invoke an ASR model to recognize the second speech information, so as to obtain the object review information for the target review object. In another mode, the payment interaction device transmits the second speech information to the server, and the server invokes an ASR model to recognize the second speech information, so as to obtain the object review information for the target review object.

As shown in (B) in FIG. 17, N3 is configured for indicating the object review information for the target review object. N4 is configured for indicating an upload control. When the user taps the upload control indicated by N4, an upload operation on the object review information is triggered, and thereby, the payment interaction device transmits the object review information to the application server. Based on this, the object review information for the target review object may be viewed or heard in the application client.

Moreover, in this embodiment of this disclosure, a mode of commenting on objects in an order is provided. In the foregoing mode, because one order may include a plurality of evaluable objects (such as items or service staff), the user may further choose to review one or more of the objects. Thereby, flexibility of reviewing is improved.

In some embodiments, based on one or more embodiments corresponding to FIG. 4 or FIG. 12 described above, in another exemplary embodiment provided in this embodiment of this disclosure, the method may further include:
obtaining a to-be-recognized image by using an image acquisition apparatus;
recognizing the to-be-recognized image to obtain an image recognition result;
obtaining, if the image recognition result indicates that the to-be-recognized image is an image of a target item, item review information for the target item; and
transmitting, in response to an upload operation on the item review information, the item review information to the application server, the application server being configured to transmit the item review information to the target terminal such that the target terminal displays the item review information by using the application client.

In one or more embodiments, a mode of reviewing the item is described. As can be known from the foregoing embodiment, by using the image acquisition apparatus (for example, a camera), the payment interaction device not only can acquire biometric features, but also can acquire object features. Based on this, the specific item can be recognized according to the object features.

In one mode, the payment interaction device may invoke an image recognition model to recognize the to-be-recognized image, so as to obtain the image recognition result. In another mode, the payment interaction device transmits the to-be-recognized image to the server, and the server invokes the image recognition model to recognize the to-be-recognized image, so as to obtain the image recognition result. Configuration of the image recognition model may be deployed on the payment interaction device, or configuration of the image recognition model may be deployed on the server, configuration of the image recognition model is partially deployed on the payment interaction device and partially deployed on the server. This is not limited herein.

Specifically, for ease of understanding, referring to FIG. 18, FIG. 18 is a schematic diagram of uploading item review information according to an embodiment of this disclosure. As shown in (A) in FIG. 18, Q1 is configured for indicating the payment interaction device. Q2 is configured for indicating a to-be-recognized item. As can be seen, the payment interaction device captures a to-be-recognized image by using the image acquisition apparatus, and recognizes the to-be-recognized image to obtain the image recognition result. Assuming that the image recognition result is that the to-be-recognized image includes an image of a “smart headset”, then the “smart headset” is the target item. As shown in (B) in FIG. 18, Q3 is configured for indicating the image recognition result (for example, “smart headset”). Q4 is configured for indicating a review control. When the user taps the review control indicated by Q4, the item review information for the target item may be inputted in a mode of a text or a speech. Thereby, as shown in (C) in FIG. 18, Q5 is configured for indicating the item review information for the target item. Q6 is configured for indicating an upload control. When the user taps the upload control indicated by Q6, an upload operation on the item review information is triggered, and thereby the payment interaction device transmits the item review information to the application server. Based on this, the item review information for the target item may be viewed or heard in the application client.

In addition, in this embodiment of this disclosure, a mode of reviewing an item is provided. In the foregoing mode, the payment interaction device may further recognize the image, so as to recognize the image including the item. Based on this, a review interface corresponding to the item may be automatically displayed, so that the user can review the item.

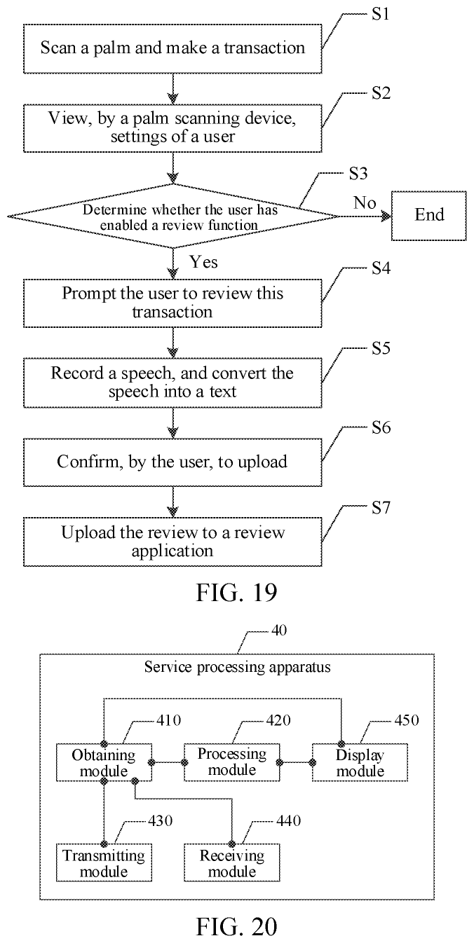

Based on the embodiments corresponding to FIG. 12, the following describes an overall flow with reference to FIG. 18. Referring to FIG. 19, FIG. 19 is a schematic flowchart of another application of a service processing method according to an embodiment of this disclosure. As shown in the figure, specifically:
In operation S1, a user scans a palm and makes a transaction.
In operation S2, a palm scanning device views settings of the user after the transaction is completed.
In operation S3, it is determined, based on the settings of the user, whether the user has enabled a palm scanning review function, and if the function has been enabled, operation S4 is performed, or if the function has not been enabled, an entire process ends.
In operation S4, the palm scanning device may prompt, by using a text or a speech, the user to review this transaction.
In operation S5, if the user chooses to comment, the palm scanning device records a speech of the user, and converts the speech of the user into a text and then displays the text to the user. If the user does not want to comment, the user may tap on the interface to exit.
In operation S6, the user confirms to upload a review content by using the palm scanning device.
In operation S7, the palm scanning device uploads the review content of the user to a review application.

The following describes a service processing apparatus in this application in detail. Referring to FIG. 20, FIG. 20 is a schematic diagram of an embodiment of a service processing apparatus according to an embodiment of this disclosure. The service processing apparatus 40 includes:
an obtaining module 410, configured to acquire first biometric data in a case of displaying a first advertisement content, the first advertisement content being an advertisement content corresponding to a first item, and the first biometric data including a to-be-recognized biometric feature,
the obtaining module 410 being further configured to obtain, if the first biometric data is successfully matched with prestored biometric data of a target object, payment information corresponding to the target object, the prestored biometric data being biometric data acquired in advance for the target object; and
a processing module 420, configured to execute, in response to a confirmation operation on order information for the first item, a payment operation according to the payment information.

In some embodiments, the obtaining module 410 is further configured to obtain, if the first biometric data is successfully matched with the prestored biometric data of the target object, payment information and recipient information that correspond to the target object. The recipient information includes at least one of a mailing address and account information, and the recipient information is an address for receiving the first item in a case of successful payment.

In some embodiments, based on the embodiment corresponding to FIG. 20 described above, in another embodiment of the service processing apparatus 40 provided in this embodiment of this disclosure, the service processing apparatus further includes a transmitting module 430, a receiving module 440, and a display module 450.

The transmitting module 430 is further configured to transmit, after the first biometric data is acquired, an advertisement lock request to an advertisement display module by using a payment interaction module, to generate a lock response message by using the advertisement display module. The lock response message carries an identity document of the first item.

The receiving module 440 is configured to receive the lock response message transmitted by the advertisement display module by using the payment interaction module.

Alternatively,
the display module 450 is configured to lock the first advertisement content in response to the advertisement lock request.

In some embodiments, based on the embodiment corresponding to FIG. 20 described above, in another embodiment of the service processing apparatus 40 provided in this embodiment of this disclosure,
the transmitting module 430 is further configured to transmit, after the first biometric data is acquired, an advertisement lock request to an advertisement display module by using a payment interaction module, to continuously display the first advertisement content within a preset duration by using the advertisement display module.

If no biometric data is acquired within the preset duration, in a case that the preset duration ends, a second advertisement content is displayed. The second advertisement content is an advertisement content corresponding to a second item.

If third biometric data is acquired within the preset duration and the third biometric data is successfully matched with first prestored biometric data of a first object, first payment information corresponding to the first object is obtained, and an order information for the first item related to the first object is displayed.

In some embodiments, based on the embodiment corresponding to FIG. 20 described above, in another embodiment of the service processing apparatus 40 provided in this embodiment of this disclosure,
the transmitting module 430 is further configured to transmit, after the first biometric data is acquired, an advertisement lock request to an advertisement display module by using a payment interaction module, to provide a queuing control by using the advertisement display module when the first advertisement content is displayed.

The display module 440 is further configured to display the first advertisement content continuously if a response to a selection operation on the queuing control is received.

The display module 440 is further configured to display a second advertisement content if no response to a selection operation on the queuing control is received in a case that display of the first advertisement content is completed. The second advertisement content is an advertisement content corresponding to a second item.

In some embodiments, based on the embodiment corresponding to FIG. 20 described above, in another embodiment of the service processing apparatus 40 provided in this embodiment of this disclosure,
the obtaining module 410 is further configured to acquire second biometric data in a case that an item information set is displayed. The item information set is at least one piece of item information recommended based on a face recognition result, and the second biometric data includes a to-be-recognized biometric feature.

The obtaining module 410 is further configured to obtain payment information and recipient information that correspond to the target object if a response to an order placement operation for a third item is received and the second biometric data is successfully matched with the prestored biometric data. The third item is an item corresponding to target item information, and the target item information is one piece of item information in the item information set.

The display module 440 is further configured to transmit an order placement request by using a payment interaction module, to display order information for the third item by using an advertisement display module. The order placement request carries the payment information, the recipient information, and an identity document of the third item, and the recipient information is an address also for receiving the third item in a case of successful payment.

In some embodiments, based on the embodiment corresponding to FIG. 20 described above, in another embodiment of the service processing apparatus 40 provided in this embodiment of this disclosure,
the processing module 420 is specifically configured to obtain a speech instruction by using a speech input apparatus; and
execute, in a case that the speech instruction meets an instruction trigger condition, the payment operation according to the payment information in response to the confirmation operation on the order information for the first item, where
the case that the instruction trigger condition is met includes at least one of the following:
after recognizing the speech instruction, it is determined that a text instruction corresponding to the speech instruction includes a trigger word; and
after recognizing the speech instruction, it is determined that an initiator of the speech instruction is the target object.

In some embodiments, based on the embodiment corresponding to FIG. 20 described above, in another embodiment of the service processing apparatus 40 provided in this embodiment of this disclosure, the order information further includes a purchase quantity.

The obtaining module 410 is further configured to obtain target text information by using at least one of a touchscreen, physical keys, or projection keys.

The obtaining module 410 is further configured to determine a purchase quantity according to the target text information.

Alternatively,
the obtaining module 410 is further configured to obtain target speech information by using a speech input apparatus.

The obtaining module 410 is further configured to determine a purchase quantity according to the target speech information.

In some embodiments, based on the embodiment corresponding to FIG. 20 described above, in another embodiment of the service processing apparatus 40 provided in this embodiment of this disclosure,
the transmitting module 430 is further configured to transmit, in a case of failed payment, item information for the first item to a target terminal used by the target object. The target terminal is configured to display the item information for the first item.

In some embodiments, based on the embodiment corresponding to FIG. 20 described above, in another embodiment of the service processing apparatus 40 provided in this embodiment of this disclosure, the mailing address is a default recipient address preset by using the terminal, and the account information is an account associated with the target object.

In a case that the first item is a physical item, the recipient information is the mailing address.

In a case that the first item is a virtual item, the recipient information is the account information.

In some embodiments, based on the embodiment corresponding to FIG. 20 described above, in another embodiment of the service processing apparatus 40 provided in this embodiment of this disclosure,
the obtaining module 410 is further configured to acquire, for a target order, target biometric data. The target order belongs to orders of a target merchant, and the target biometric data includes a to-be-recognized biometric feature.

The processing module 440 is further configured to execute, if the target biometric data is successfully matched with the prestored biometric data, a payment operation on the target order by using the payment information corresponding to the target object.

The obtaining module 410 is further configured to acquire, if it is detected that the account of the target object has enabled a review function in a case of successful payment, first speech information by using the speech input apparatus.

The obtaining module 410 is further configured to obtain, according to the first speech information, order review information for the target merchant.

The transmitting module 430 is further configured to transmit, in response to an upload operation on the order review information, the order review information to an application server. The application server is configured to transmit the order review information to the target terminal such that the target terminal displays the order review information by using an application client.

In some embodiments, based on the embodiment corresponding to FIG. 20 described above, in another embodiment of the service processing apparatus 40 provided in this embodiment of this disclosure, the service processing apparatus 40 further includes a display module 450.

The obtaining module 410 is specifically configured to recognize the first speech information to obtain to-be-processed text information; and
use, if the to-be-processed text information does not include any violation words, the first speech information as the order review information for the target merchant.

The display module 450 is configured to display, if the to-be-processed text information includes at least one violation word, a notification message indicating comment failed.

In some embodiments, based on the embodiment corresponding to FIG. 20 described above, in another embodiment of the service processing apparatus 40 provided in this embodiment of this disclosure,
the obtaining module 410 is specifically configured to recognize the first speech information to obtain to-be-processed text information; and
use, if the to-be-processed text information does not include any violation words, the to-be-processed text information as the order review information for the target merchant.

The display module 450 is further configured to highlight, if the to-be-processed text information includes at least one violation word, the at least one violation word.

In some embodiments, based on the embodiment corresponding to FIG. 20 described above, in another embodiment of the service processing apparatus 40 provided in this embodiment of this disclosure,
the processing module 440 is further configured to perform, after the first speech information is acquired by using the speech input apparatus, emotion recognition on the first speech information to obtain an emotion recognition result.

The transmitting module 430 is further configured to transmit, if the emotion recognition result indicates that the first speech information is speech information with negative emotions, a discount application request to the application server. The discount application request carries the account of the target object and an identity document of the target merchant, and the application server is configured to transmit an electronic coupon to the target terminal used by the target object.

In some embodiments, based on the embodiment corresponding to FIG. 20 described above, in another embodiment of the service processing apparatus 40 provided in this embodiment of this disclosure,
the display module 450 is further configured to display, in a case of successful payment, K rating options for the target order. Each rating option corresponds to one rating score, and K is an integer greater than 1.

The transmitting module 430 is further configured to transmit, in response to a selection operation on a target rating option, a rating score corresponding to the target rating option to the application server such that the application server updates a merchant score of the target merchant according to the rating score. The target rating option is one of the K rating options, and the application server is configured to transmit the merchant score to the target terminal such that the target terminal displays the merchant score by using the application client.

In some embodiments, based on the embodiment corresponding to FIG. 20 described above, in another embodiment of the service processing apparatus 40 provided in this embodiment of this disclosure,
the display module 450 is further configured to display, if it is detected that the account of the target object has enabled the review function in a case of successful payment, M review objects corresponding to the target order. M is an integer greater than or equal to 1.

The obtaining module 410 is further configured to acquire, in response to a selection operation on a target review object, second speech information by using the speech input apparatus. The target review object is one of the M review objects.

The obtaining module 410 is further configured to obtain, according to the second speech information, object review information for the target review object.

The transmitting module 430 is further configured to transmit, in response to an upload operation on the object review information, the object review information to the application server. The application server is configured to transmit the object review information to the target terminal such that the target terminal displays the object review information by using the application client.

In some embodiments, based on the embodiment corresponding to FIG. 20 described above, in another embodiment of the service processing apparatus 40 provided in this embodiment of this disclosure,
the obtaining module 410 is further configured to obtain a to-be-recognized image by using an image acquisition apparatus.

The processing module 440 is further configured to recognize the to-be-recognized image to obtain an image recognition result.

The obtaining module 410 is further configured to obtain, if the image recognition result indicates that the to-be-recognized image is an image of a target item, item review information for the target item.

The transmitting module 430 is further configured to transmit, in response to an upload operation on the item review information, the item review information to the application server. The application server is configured to transmit the item review information to the target terminal such that the target terminal displays the item review information by using the application client.

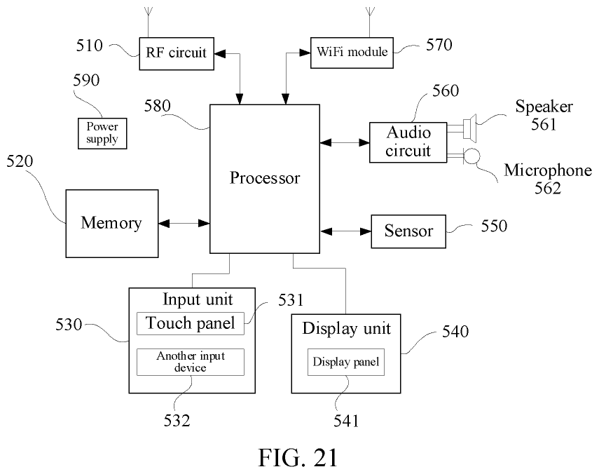

An embodiment of this disclosure further provides a terminal. As shown in FIG. 21, for ease of description, only parts related to this embodiment of this disclosure are shown. For specific technical details that are not disclosed, reference may be made to the method section in the embodiments of this application. In this embodiment of this disclosure, description is provided in an example in which the terminal is a payment interaction device.

FIG. 21 is a block diagram of a partial structure of a payment interaction device related to the terminal provided in this embodiment of this disclosure. Referring to FIG. 21, the payment interaction device includes: components such as a radio frequency (RF) circuit 510, a memory 520, an input unit 530, a display unit 540, a sensor 550, an audio circuit 560, a wireless fidelity (WiFi) module 570, a processor 580, and a power supply 590. Those skilled in the art may understand that the structure of the payment interaction device shown in FIG. 21 does not constitute a limitation to the payment interaction device. The payment interaction device may include more or fewer components than those shown in the figure, may combine some components, or may have different component arrangements.

The following specifically describes the components of the payment interaction device with reference to FIG. 21.

The RF circuit 510 may be configured to receive and transmit a signal during information reception and transmission or calling. Particularly, after receiving downlink information from a base station, the RF circuit transmits the downlink information to the processor 580 for processing. In addition, the RF circuit transmits designed uplink data to the base station. Generally, the RF circuit 510 includes, but is not limited to, an antenna, at least one amplifier, a transceiver, a coupler, a low noise amplifier (LNA), a duplexer, and the like. In addition, the RF circuit 510 may also communicate with a network and another device in a wireless mode. The foregoing wireless communication may use any communication standard or protocol, including, but not limited to, global system of mobile communication (GSM), general packet radio service (GPRS), code division multiple access (CDMA), wideband code division multiple access (WCDMA), long term evolution (LTE), Email, short messaging service (SMS), and the like.

The memory 520 may be configured to store a software program and a module. The processor 580 runs the software program and the module that are stored in the memory 520, to perform various functional applications and data processing of the payment interaction device. The memory 520 may mainly include a program storage area and a data storage area. The program storage area may store an operating system, an application program required by at least one function (for example, a sound play function and an image play function), and the like. The data storage area may store data (such as audio data) created according to the use of the payment interaction device and the like. In addition, the memory 520 may include a high speed random-access memory, and may also include a non-volatile memory, such as at least one magnetic disk storage device, a flash memory, or another volatile solid-state storage device.

The input unit 530 may be configured to receive inputted digit or character information, and generate a key signal input related to user settings and function control of the payment interaction device. Specifically, the input unit 530 may include a touch panel 531 and another input device 532. The touch panel 531, also referred to as a touchscreen, may collect a touch operation that is performed by a user on or near the touch panel 531 (for example, an operation that is performed by a user by using any appropriate object or accessory such as a finger or a stylus on or near the touch panel 531), and drive a corresponding connection apparatus according to a preset program. In some embodiments, the touch panel 531 may include two parts: a touch detection apparatus and a touch controller. The touch detection apparatus detects a touch orientation of the user and a signal generated by a touch operation, and transmits the signal to the touch controller. The touch controller receives touch information from the touch detection apparatus, converts the touch information into touch point coordinates, and then transmits the touch point coordinates to the processor 580. Moreover, the touch controller can receive a command transmitted from the processor 580 and execute the command. In addition, the touch panel 531 may be implemented in various types, such as a resistive type, a capacitive type, an infrared type, and a surface sound wave type. In addition to the touch panel 531, the input unit 530 may further include the another input device 532. Specifically, the another input device 532 may include, but is not limited to, one or more of a physical keyboard, a functional key (such as a volume control key and an on/off key), a mouse, and a joystick, and the like.

The display unit 540 may be configured to display information inputted by the user or information provided for the user, and various menus of the payment interaction device. The display unit 540 may include a display panel 541. In some embodiments, the display panel 541 may be configured in the form of a liquid crystal display (LCD), an organic light-emitting diode (OLED), and the like. Further, the touch panel 531 may cover the display panel 541. After detecting a touch operation on or near the touch panel, the touch panel 531 transfers the touch operation to the processor 580, to determine a type of a touch event. Then, the processor 580 provides a corresponding visual output on the display panel 541 according to the type of the touch event. Although in FIG. 21, the touch panel 531 and the display panel 541 are used as two separate components to implement input and output functions of the payment interaction device, in some embodiments, the touch panel 531 and the display panel 541 may be integrated to implement the input and output functions of the payment interaction device.

The payment interaction device may further include at least one sensor 550 such as an optical sensor, a motion sensor, and other sensors.

The audio circuit 560, a speaker 561, and a microphone 562 may provide an audio interface between the user and the payment interaction device. The audio circuit 560 may transmit an electrical signal converted from received audio data to the speaker 561, and the speaker 561 converts the electrical signal into a sound signal for output. In another aspect, the microphone 562 converts the collected sound signal into an electrical signal. The audio circuit 560 receives the electrical signal, converts the electrical signal into audio data, and then outputs the audio data to the processor 580 for processing. Then, the processor transmits the audio data to, for example, another payment interaction device via the RF circuit 510, or outputs the audio data to the memory 520 for further processing.

WiFi is a short-distance wireless transmission technology. The payment interaction device may help, by using the WiFi module 570, a user to receive and transmit an Email, browse a web page, access stream media, and the like, to allow wireless broadband Internet access of the user. Although FIG. 21 shows the WiFi module 570, the WiFi module is not a necessary component of the payment interaction device, and may be omitted as needed provided that the scope of the essence of the present disclosure is not changed.

The processor 580, as a control center of the payment interaction device, connects all parts of the entire payment interaction device by using various interfaces and lines, and executes various functions of the payment interaction device and processes data by running or executing the software program and/or module stored in the memory 520 and invoking data stored in the memory 520. In some embodiments, the processor 580 may include one or more processing units. In some embodiments, the processor 580 may integrate an application processor and a modem processor. The application processor mainly processes an operating system, a user interface, an application, and the like. The modem processor mainly processes wireless communication. The foregoing modem processor may not be integrated into the processor 580.

The payment interaction device further includes the power supply 590 (such as a battery) for supplying power to the components. In some embodiments, the power supply may be logically connected to the processor 580 by using a power management system, thereby implementing functions such as charging and discharging management and power consumption management by using the power management system.

Although not shown in the figure, the payment interaction device may further include a camera, a Bluetooth module, and the like, which are not described in detail herein.

Operations executed by the terminal in the foregoing embodiments may be based on the structure of the terminal shown in FIG. 21.

An embodiment of this disclosure further provides a computer device, including a memory and a processor, the memory having a computer program stored therein, the processor, when executing the computer program, implementing operations of the method described in the foregoing embodiments.

An embodiment of this disclosure further provides a computer-readable storage medium (e.g., non-transitory storage medium), having a computer program stored therein, the computer program, when executed by a processor, implementing operations of the method described in the foregoing embodiments.

An embodiment of this disclosure further provides a computer program product, including a computer program, the computer program, when executed by a processor, implementing operations of the method described in the foregoing embodiments.

A person skilled in the art may clearly understand that, for convenience and conciseness of description, for specific working processes of the foregoing described system, apparatus and unit, reference can be made to the corresponding processes in the foregoing method embodiments, and details are not described herein again.

In the embodiment of this disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processor or memories) may be configured to realize one or more modules or units. In addition, each module or unit may be a part of an overall module or unit including the module or unit function.

In the several embodiments provided in this application, the disclosed system, apparatus, and method can be implemented in other modes. For example, the foregoing described apparatus embodiment is merely illustrative. For example, the unit division is merely logical function division and there may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separated, and components displayed as units may or may not be physical units, that is, may be located in one position, or may be distributed on a plurality of network units. Some or all of the units may be selected according to actual needs to achieve the objectives of the solution of the embodiment.

In addition, the function units in the embodiments of this application may be integrated into one processing unit, or each of the units may exist alone physically, or two or more units are integrated into one unit. The foregoing integrated unit may be implemented in a form of hardware, or may be implemented in a form of a software function unit.

When the integrated unit is implemented in the form of the software function unit, and sold or used as an independent product, the integrated unit may be stored in a computer-readable storage medium. Based on this understanding, the technical solutions of this application essentially, or the part contributing to the related art, or all or some of the technical solutions may be implemented in the form of a software product. The computer software product is stored in a storage medium and includes several instructions for instructing a computer device (which may be a server, a terminal device, or the like) to perform all or some of the operations of the method in the embodiments of this application. However, the foregoing storage medium includes various media that can store computer programs, such as a universal serial bus (USB) flash drive, a removable hard disk, a read-only memory (ROM), a random access memory (RAM), a magnetic disk, or an optical disc.

Based on the above, the foregoing embodiments are merely configured for describing the technical solutions of this application, but are not intended to limit this application. Although this application is described in detail with reference to the foregoing embodiments, a person of ordinary skill in the art is to understand that modifications may still be made to the technical solutions described in the foregoing embodiments or equivalent replacements may be made to some technical features thereof. These modifications or replacements do not cause the essence of corresponding technical solutions to depart from the spirit and scope of the technical solutions in the embodiments of this application.

What is claimed is:

1. A method for service processing, executed by a terminal, the method comprising:
acquiring first biometric data while displaying a first advertisement content, the first advertisement content being an advertisement content corresponding to a first item, and the first biometric data comprising a to-be-recognized biometric feature;
obtaining, if the first biometric data is successfully matched with prestored biometric data of a target object, payment information corresponding to the target object, the prestored biometric data being biometric data acquired in advance for the target object; and
executing, in response to a confirmation operation on order information for the first item, a payment operation according to the payment information.

2. The method according to claim 1, wherein obtaining the payment information corresponding to the target object comprises:
obtaining, if the first biometric data is successfully matched with the prestored biometric data of the target object, payment information and recipient information that correspond to the target object, the recipient information comprising at least one of a mailing address and account information, and the recipient information being an address for receiving the first item upon successful payment.

3. The method according to claim 1, wherein after acquiring first the biometric data, the method further comprises:
transmitting, by a payment interaction module, an advertisement lock request to an advertisement display module to cause the advertisement display module to generate a lock response message by using the advertisement display module, the lock response message carrying an identity document of the first item; and
receiving the lock response message transmitted by the advertisement display module by using the payment interaction module;
or
locking the first advertisement content in response to the advertisement lock request.

4. The method according to claim 1, wherein after acquiring the first biometric data, the method further comprises:
transmitting, by a payment interaction module, an advertisement lock request to an advertisement display module to cause the advertisement display module to continuously display the first advertisement content within a preset duration by, wherein
if no biometric data is acquired within the preset duration, upon expiration of the preset duration, a second advertisement content is displayed, the second advertisement content being an advertisement content corresponding to a second item; and
if third biometric data is acquired within the preset duration and the third biometric data is successfully matched with prestored biometric data of a first object, first payment information corresponding to the first object is obtained, and an order information for the first item associated with the first object is displayed.

5. The method according to claim 1, wherein after acquiring first biometric data, the method further comprises:
transmitting, by a payment interaction module, an advertisement lock request to an advertisement display module to cause the advertisement display module to provide a queuing control while displaying the first advertisement content;
continuing to display the first advertisement content if a response to a selection operation on the queuing control is received; and
displaying a second advertisement content if no response to a selection operation on the queuing control is received upon completion of displaying the first advertisement content, the second advertisement content being an advertisement content corresponding to a second item.

6. The method according to claim 1, further comprising:
acquiring second biometric data while displaying an item information set, the item information set being at least one piece of item information recommended based on a face recognition result, and the second biometric data comprising a to-be-recognized biometric feature;
obtaining payment information and recipient information that correspond to the target object if a response to an order placement operation for a third item is received and the second biometric data is successfully matched with the prestored biometric data, the third item being an item corresponding to target item information, and the target item information being one piece of item information in the item information set; and
transmitting, by a payment interaction module, an order placement request, to cause an advertisement display module to display order information for the third item, the order placement request carrying the payment information, the recipient information, and an identity document of the third item, and the recipient information being an address also for receiving the third item upon successful payment.

7. The method according to claim 1, wherein executing, in response to the confirmation operation on order information for the first item, the payment operation according to the payment information comprises:
obtaining a speech instruction by using a speech input apparatus; and
executing, when the speech instruction satisfies an instruction trigger condition, the payment operation according to the payment information in response to the confirmation operation on the order information for the first item, wherein
the instruction trigger condition is satisfied upon at least one of the following:
upon recognizing the speech instruction, determining that a text instruction corresponding to the speech instruction comprises a trigger word; and
upon recognizing the speech instruction, determining that an initiator of the speech instruction is the target object.

8. The method according to claim 1, wherein the order information further comprises a purchase quantity, and wherein the method further comprises:
obtaining target text information by using at least one of a touchscreen; physical keys; or projection keys; and determining a purchase quantity according to the target text information;
or
obtaining target speech information by using a speech input apparatus; and determining a purchase quantity according to the target speech information.

9. The method according to claim 1, the method further comprising:
transmitting, upon a failed payment, item information for the first item to a target terminal associated with the target object, the target terminal being configured to display the item information for the first item.

10. The method according to claim 2, wherein:
the mailing address is a default recipient address preset by using the terminal, and the account information is an account associated with the target object;
when the first item is a physical item, the recipient information is the mailing address; and
when the first item is a virtual item, the recipient information is the account information.

11. The method according to claim 1, further comprising:
acquiring, for a target order, target biometric data, the target order belonging to orders of a target merchant, and the target biometric data comprising a to-be-recognized biometric feature;
executing, if the target biometric data is successfully matched with the prestored biometric data, a payment operation on the target order by using the payment information corresponding to the target object;
acquiring, if it is detected that the account of the target object has enabled a review function upon successful payment, first speech information by using the speech input apparatus;
obtaining, according to the first speech information, order review information for the target merchant; and
transmitting, in response to an upload operation on the order review information, the order review information to an application server, the application server being configured to transmit the order review information to a target terminal such that the target terminal displays the order review information by using an application client.

12. The method according to claim 11, wherein:
obtaining, according to the first speech information, order review information for the target merchant comprises:
recognizing the first speech information to obtain to-be-processed text information; and
if the to-be-processed text information does not comprise any violation words, using the first speech information as the order review information for the target merchant; and
the method further comprises:
displaying, if the to-be-processed text information comprises at least one violation word, a notification message indicating that a comment failed.

13. The method according to claim 11, wherein: the:
obtaining, according to the first speech information, order review information for the target merchant comprises:
recognizing the first speech information to obtain to-be-processed text information; and
using, if the to-be-processed text information does not comprise any violation words, the to-be-processed text information as the order review information for the target merchant; and
the method further comprises:
highlighting, if the to-be-processed text information comprises at least one violation word, the at least one violation word.

14. The method according to claim 11, wherein, after acquiring the first speech information by using the speech input apparatus, the method further comprises:
performing emotion recognition on the first speech information to obtain an emotion recognition result; and
transmitting, if the emotion recognition result indicates that the first speech information is speech with negative emotions, a discount application request to the application server, the discount application request carrying the account of the target object and an identity document of the target merchant, and the application server being configured to transmit an electronic coupon to the target terminal associated with the target object.

15. The method according to claim 11, further comprising:
displaying, upon successful payment, K rating options for the target order, each rating option corresponding to a rating score, and K being an integer greater than 1; and
transmitting, in response to a selection operation on a target rating option, a rating score corresponding to the target rating option to the application server such that the application server updates a merchant score of the target merchant according to the rating score, the target rating option being one of the K rating options, and the application server being configured to transmit the merchant score to the target terminal such that the target terminal displays the merchant score by using the application client.

16. The method according to claim 11, further comprising:
displaying, if it is detected that the account of the target object has enabled the review function upon successful payment, M review objects corresponding to the target order, M being an integer greater than or equal to 1;
acquiring, in response to a selection operation on a target review object, second speech information by using the speech input apparatus, the target review object being one of the M review objects;
obtaining, according to the second speech information, object review information for the target review object; and
transmitting, in response to an upload operation on the object review information, the object review information to the application server, the application server being configured to transmit the object review information to the target terminal such that the target terminal displays the object review information by using the application client.

17. The method according to claim 11, further comprising:
obtaining a to-be-recognized image by using an image acquisition apparatus;
recognizing the to-be-recognized image to obtain an image recognition result;
obtaining, if the image recognition result indicates that the to-be-recognized image is an image of a target item, item review information for the target item; and
transmitting, in response to an upload operation on the item review information, the item review information to the application server, the application server being configured to transmit the item review information to the target terminal such that the target terminal displays the item review information by using the application client.

18. A device comprising a memory for storing computer instructions and a processor in communication with the memory, wherein, when the processor executes the computer instructions, the processor is configured to cause the device to:
acquire first biometric data while displaying a first advertisement content, the first advertisement content being an advertisement content corresponding to a first item, and the first biometric data comprising a to-be-recognized biometric feature;
obtain, if the first biometric data is successfully matched with prestored biometric data of a target object, payment information corresponding to the target object, the prestored biometric data being biometric data acquired in advance for the target object; and
execute, in response to a confirmation operation on order information for the first item, a payment operation according to the payment information.

19. The device according to claim 18, wherein, when the processor is configured to cause the device to obtain the payment information corresponding to the target object, the processor is configured to cause the device to:
obtain, if the first biometric data is successfully matched with the prestored biometric data of the target object, payment information and recipient information that correspond to the target object, the recipient information comprising at least one of a mailing address and account information, and the recipient information being an address for receiving the first item upon successful payment.

20. A non-transitory storage medium for storing computer readable instructions, the computer readable instructions, when executed by a processor, causing the processor to:
acquire first biometric data while displaying a first advertisement content, the first advertisement content being an advertisement content corresponding to a first item, and the first biometric data comprising a to-be-recognized biometric feature;
obtain, if the first biometric data is successfully matched with prestored biometric data of a target object, payment information corresponding to the target object, the prestored biometric data being biometric data acquired in advance for the target object; and
execute, in response to a confirmation operation on order information for the first item, a payment operation according to the payment information.
